(19) United States
(12) Patent Application Publication
(10) Pub. No.: US 2011/0022941 A1
(43) Pub. Date: Jan. 27, 2011

(54) Information Extraction Methods and Apparatus Including a Computer-User Interface

(76) Inventors: Brian Osborne, Nyack, NY (US); David Michael Rubin, Maplewood, NJ (US); Rodrigo James Vicente Barnes, Dunbar (GB)

Correspondence Address: NIXON & VANDERHYE, PC, 901 NORTH GLEBE ROAD, 11TH FLOOR, ARLINGTON, VA, 22203, US

(21) Appl. No.: 12/226,267

(22) PCT Filed: Mar. 30, 2007
(86) PCT No.: PCT/GB2007/001170

§ 371 Date: Jul. 28, 2010

(30) Foreign Application Priority Data
Apr. 11, 2006 (GB) 0607236.7
Feb. 27, 2007 (GB) 0703821.9

(51) Int. Cl. G06F 17/00

(52) U.S. Cl. 715/230

(57) ABSTRACT

Disclosed is an information extraction system and method. The method comprises receiving a document and annotation data, the annotation data comprising instances of entities which have been identified in the document, the annotation entity data comprising identifiers of instances of one or more entities which have been identified in the document and data specifying the location of the identified instances of entities within the document, wherein the identifiers of instances of entities comprise references to ontology data; displaying the document to a user, with annotations dependent on the annotation data, highlighting one or more of the instances of entities whose location is specified in the annotation entity data at the location within the document specified by the annotation entity data; preparing revised annotation data from a user and outputting output data derived from the amended annotation data. The output data is typically used to populate a database.

### FIELD OF THE INVENTION

The present invention relates to the extraction of information from documents comprising or consisting of text, such as scientific and technical literature. An information extraction procedure and computer-user interface facilitates the population of a database, the creation or amendment of an ontology database and/or the training of a trainable information extraction module.

### BACKGROUND TO THE INVENTION

The ever increasing volume of information produced by society and industry has led to ever increasing difficulties in storing, finding and analysing that information. Whereas there was a time when information, such as scientific and technical literature, could be adequately stored in printed form and indexed by hand, that time is now in the past and electronic storage, retrieval and analysis systems are an essential part of the modern world.

Some types of information processing can be adequately addressed by computerised analysis alone. For example, searchable directories of web pages can be automatically prepared without human intervention and used to store large volumes of information and to retrieve this information in response to queries, such as which web pages include specific words.

However, some information processing tasks cannot be automated, or cannot be automated to the standard which would be achieved by a human. For example, the accurate automatic analysis of documents comprising natural language text constitutes an especially difficult problem.

The automatic analysis of natural language text documents is addressed by the growing scientific field of natural language processing (NLP), also referred to as computational linguistics. NLP has been used to carry out tasks which previously required to be carried out by humans, but remains an imperfect science under continual development. Although it is often desirable to use automatic methods of analysing natural language, rather than human analysis, due to the cost and speed benefits of computerisation, there are many applications where human analysis remains essential.

One example of a field where there is a large volume of information, which would ideally be analysed automatically where possible, is the scientific literature, for example the biomedical scientific literature. In order to make new scientific discoveries and draw conclusions from existing data, it is desirable to be able to store and recall information concerning relations between biological entities which are mentioned in the scientific literature. For example, where a scientific paper provides evidence to support a hypothesis that a first protein interacts with a second protein in vivo, it is desirable to store that information in a searchable database. Such databases can be valuable aids to technical progress.

International Patent Application Publication Number WO 2005/017692 (Cognia Corporation) describes a relational database for use in biomedical research which includes information about entities (such as proteins, genes, compounds etc.) and interactions between these entities. Data concerning interactions is stored in the database along with references to scientific papers which provide evidence for the interactions. Thus, the database can be queried by users not just to find out information about entities and interactions between entities, but also to thereby identify relevant sources within the scientific literature. Data is entered into the database by human curators who read scientific literature, identify entities referred to in individual documents and relations which are hypothesized, discussed or proven by data within those documents. A computer-user interface is provided to curators which allows them to input data by selecting options via an ontology browser which, amongst other data, defines normalised forms for the names of entities. Thus, the data inputted by the curators uses standardised terms, which avoids entities being referred to by different names and thus improves the quality of the database.

However, a disadvantage of the system described in WO 2005/017692 is that it requires a substantial amount of time to be spent by skilled curators to compile the database, which can be costly. It would be advantageous to find a method of populating a database which had a reduced requirement for manpower.

Accordingly, it is an object of some embodiments of the present invention to provide improved methods and apparatus for populating a database, creating or amending an ontology database and/or training a trainable information extraction module.

The invention will be discussed using examples taken from the field of biomedical scientific literature for illustrative purposes. However, the invention is applicable to the analysis of any other type of document from any other field, such as physics, electronics, engineering, geophysics, mathematics or patent literature.

### SUMMARY OF THE INVENTION

According to a first aspect of the present invention there is provided a method of editing annotation data associated with a digital representation of a document, the method comprising the steps carried out by computing apparatus of:
(i) receiving as input data a digital representation of a document and annotation data, the annotation data comprising annotation entity data concerning one or more instances of entities which have been identified in the digital representation of a document, the annotation entity data comprising identifiers of instances of one or more entities which have been identified in the digital representation of a document and data specifying the location of the identified instances of entities within the digital representation of a document, wherein the identifiers of instances of entities comprise references to ontology data;
(ii) displaying at least part of the digital representation of a document to a user of computer-user interface means (such as a computer-user interface), with annotations dependent on the annotation data, the said annotations including at least highlighting one or more of the instances of entities whose location is specified in the annotation entity data at the location within the digital representation of a document specified by the annotation entity data;
(iii) preparing amended annotation data responsive to instructions received from a user of the computer-user interface means; and
(iv) outputting output data derived from the amended annotation data.

The output data preferably comprises the amended annotation data.

In a preferred embodiment, the method of editing annotation data is part of a method of populating a database. Accordingly, the invention extends in a second aspect to a method of populating a database, the method comprising editing annotation data associated with a digital representation of a document by a method according to the first aspect of the present invention and populating the database with the output data. Within this description and the appended claims “editing annotation data” includes both amending annotation data such as to change the annotation data and preparing new annotation data or output data derived from new annotation data by amending annotation data or data derived therefrom.

Preferably, the annotation data is obtained by automatic computer analysis of the digital representation of a document.

Thus, in a third aspect, the invention also extends to a method of populating a database according to the second aspect of the invention, wherein the annotation data which is received as input data for the step of editing annotation data is obtained by the steps carried out by computing apparatus of receiving as input data a digital representation of a document, and analysing the digital representation of a document, identifying one or more instances of entities contained in the digital representation of the document and, for at least some of the identified instances of entities, storing annotation data comprising annotation entity data concerning one or more instances of entities which have been identified in the digital representation of a document, the annotation entity data comprising identifiers of instances of one or more entities which have been identified in the digital representation of a document and data specifying the location of the identified instances of entities within the digital representation of a document, wherein the identifiers of entities comprise references to ontology data, and wherein the stored annotation data is used as input data for the step of editing annotation data.

The invention therefore provides a method for enabling a human curator to review and amend annotation data derived initially by the automatic analysis by computing apparatus of a digital representation of a document. The method will typically be repeated to allow the analysis and review of digital representations of a plurality of documents.

The process of storing data which specifies the location of an instance of an entity within a digital representation of a document, and the display to a user of computer-user interface means of at least part of the analysed digital representation of a document, with one or more of the identified instances of entities highlighted at the specified location within the digital representation of a document, facilitates a human curator in reviewing and checking the automatic analysis. We have found that providing annotations on a digital representation of a document facilitates a curator in identifying relevant features which require checking and curation and improves their speed of working in comparison to a system where a curator reads a printed document and enters data concerning entities, relations etc. using a computer-user interface such as that described in WO 2005/017692.

In certain embodiments, the display of annotations which are dependent on annotation data at the location within the digital representation of a document specified by the annotation data allows the human curator to add annotation data which cannot be accurately determined by computing alone. This facilitates the correction and review by a human curator of automatically prepared annotation data.

The step of preparing amended annotation data may comprise amending the annotation data. The step of preparing amended annotation data may further comprise interactively updating the display provided by the computer-user interface means. By enabling a curator to amend the annotation data, and by interactively updating the display provided by the computer-user means, the invention may allow the human curator to more conveniently add, amend or check annotation data which is dependent on the correct annotation of an entity, for example an annotation relating to a relation between two or more entities. The resulting annotation data which has been amended by this procedure is useful for the creation or amendment of an ontology database and/or for the preparation of training data for training a trainable information extraction module.

The step of preparing amended annotation data may comprise the step of displaying provisional amended annotation data derived from (e.g. copied from or extracted from) the annotation data and updating the provisional amended annotation data responsive to instructions received from a user of the computer-user interface means. The provisional amended annotation data may be derived from annotation data responsive to selection by a user of the displayed annotation which is dependent on the said annotation data. Thus, one or more interactive user-interface elements which are displayed to a user, such as a buttons, checks boxes, text entry fields, menus, drop-down menus etc., which represent provisional amended annotation data, may be automatically pre-populated using annotation data concerning a user-selected annotation and the user may be provided with the option to interactively amend the provisional amended annotation data and its representation by the one or more interactive user-interface elements, to prepare the amended annotation data. In this case, the annotation data which was received as input data may or may not be amended.

The output data may comprise output entity data concerning one or more entities, derived from the annotation entity data. The output entity data preferably comprises identifiers of one or more entities. Typically, the identifiers of entities are references to ontology data. The output data could include the location of one or more identified instances of entities within the document, but the output data may not include the location of the identified instances of entities within the digital representation of a document.

Preferably, the output data comprises a document identifier. This makes it possible for one or more documents containing information supporting data in the database to be identified.

Preferably, the annotation data comprises annotation relation data concerning instances of relations between entities described by the digital representation of the document. The step of preparing amended annotation data may comprise the step of receiving data concerning one or more instances of relations between entities from a user of the computer-user interface means and preparing amended annotation relation data accordingly.

The amended annotation data may be in a different format to the initial (i.e. received) annotation data, but the amended annotation data may be in the same format as the initial (i.e. received) annotation data. The optional and preferred features described herein in relation to the annotation data may be optional and preferred features of the amended annotation data and, where relevant, provisional amended annotation data, throughout the method, where applicable, unless stated otherwise. Accordingly, the provisional amended annotation data may comprise provisional amended annotation entity data and provisional amended annotation relation data.

Preferably, the output data comprises output relation data concerning one or more relations between entities, which relations are described by the document, the said data concerning one or more relations derived from the amended annotation data.

Output relation data may concern a specific instance of a reference in the document to a relation between entities mentioned in the document. A relation may concern a conclusion of a document as a whole, for example, the output relation data may concern a relation which is a subject of the document, a conclusion of the document, or a hypothesis discussed or supported by the document.

It may be that the annotation data does not initially comprise annotation relation data, but that the amended annotation data does, or may, comprise annotation relation data. Thus, annotation relation data may be included within the annotation data for the first time responsive to instructions received from a user of the computer-user interface means. Where the computer-user interface means is adapted to create and display provisional amended annotation data, the computer-user interface means may allow a user to amend the provisional amended annotation data to specify a relation between entities. For example, the user may be allowed to define one or more entities to which the relation relates.

The output relation data may comprise the location of one or more instances of a relation within the digital representation of the document. The annotation relation data may comprise the location of the relation within the digital representation of a document. The step of analysing the digital representation of a document may include identifying the location of one or more instances of relations within the digital representation of a document and storing relation data specifying the location of the one or more instances of relations within the annotation data. This step may be carried out with reference to the ontology data, which may comprise ontology data concerning relations. Optionally, the annotation relation data comprises the location of one or more instances of relations within the digital representation of the data, and the output data does not comprise the location of any instances of relations within the digital representation of the data.

The identification and storage of data specifying the location of an instance of an entity within a digital representation of a document facilitates the automatic identification of relations between entities within the digital representation of a document (in embodiments which automatically identify relations between entities). This is because some relation extraction algorithms known in the art take into account the proximity of entities, or the words surrounding or between entities, when determining whether the document indicates that there is a relation between entities. The identification and storage of data specifying the instance of an entity within a digital representation of a document facilitates the provision of a computer-user interface feature enabling a user to select an entity for use in preparing amended annotation data concerning that entity or a relation concerning that entity, by pointing to the entity with a pointing device, such as a mouse.

Where the annotation data comprises annotation relation data, the method may include the step, carried out by computing apparatus, of identifying one or more instances of entities in a digital representation of a document, but not include the step, carried out by computing apparatus, of identifying instances of relations between identified entities. Thus, annotation relation data may be stored only responsively to the actions of a user of computer-user interface means. However, in a preferred embodiment, the step carried out by computing apparatus of analysing the digital representation of a document includes the step of automatically identifying instances of relations between entities and storing annotation data comprising annotation relation data concerning the identified instances of relations.

The output data may comprise data concerning relations (such as output relation data), but not data concerning entities (such as output entity data), or data concerning entities (such as output entity data) but not data concerning relations (such as output relation data), or both data concerning relations and data concerning entities (such as output relation data and output entity data).

The amendments to the annotation data responsive to instructions from a user of the computer-user interface means preferably comprise one or more of: deleting annotation entity data concerning an instance of an entity; amending annotation entity data concerning an instance of an entity, for example, by amending the data specifying the location of the said instance of an entity, or the identifier or an instance of an entity (for example, by adding or amending a reference to ontology data, such as by adding a reference to a normalised form of an entity or amending a reference to a normalised form of an entity to refer to a different normalised form of an entity); adding annotation entity data concerning an instance of an entity; deleting annotation relation data concerning an instance of a relation; amending annotation relation data concerning an instance of a relation; adding annotation relation data concerning an instance of a relation.

The annotation entity data and/or the output entity data may comprise properties of entities. The annotation relation data and/or the output relation data may comprise properties of relations.

Properties of entities may comprise one or more of: the state of an entity (e.g. whether an entity is phosphorylated) or the location of an entity (e.g. the location of an entity within a cell) or a property of an entity (e.g. the molecular weight of a protein) or a class within which the entity falls (e.g. G proteins) or a species or taxon within which the entity is classified (e.g. drosophila melanogaster or insecta). The output entity data may comprise properties of entities derived automatically from the digital representation of a document and the step of analysing the digital representation of a document may include the step carried out by computing apparatus of determining properties of entities. This step may be carried out with reference to ontology data and the ontology data may comprise data concerning properties of entities.

The output relation data may comprise properties of relations derived automatically from the digital representation of a document and the step of analysing the digital representation of a document may include the step carried out by computing apparatus of determining properties of relations. This step is preferably carried out with reference to ontology data and the ontology data may comprise data concerning properties of relations.

The amendments to the annotation entity data or provisional amended annotation entity data responsive to instructions from a user of the computer-user interface means may comprise the addition, deletion or amendment of data concerning properties of entities. The output entity data may comprise data concerning properties of entities derived from the annotation entity data.

The amendments to the annotation relation data or provisional amended annotation relation data responsive to instructions from a user of the computer-user interface means may comprise the addition, deletion or amendment of data concerning properties of the relations. The output relation data may comprise data concerning properties of relations derived from the annotation relation data.

In embodiments which allow a user to add or amend annotation entity data or provisional amended annotation data, it becomes possible for a user of the computer-user interface means (or an automatic process) to store annotation relation data concerning a relation between entities which were not identified, or were not correctly identified when the computing apparatus identified instances of entities within the digital representation of a document. The computer-user interface means may comprise user interface elements which enable a user to amend annotation relation data or provisional amended annotation data by correcting an erroneous automatic identification of an entity or to input the identifier of an unidentified entity or an entity which was identified but which was not correctly automatically identified as an entity which the relation concerns. Accordingly, this enables a curator to review and correct annotation relation data or provisional amended annotation relation data.

In a preferred embodiment, the annotation entity data concerns specific instances of an entity within the digital representation of a document, but the output data concerns the entity per se. For example, there might be five references to a single protein in a digital representation of a document (perhaps using more than one synonym of the protein), but the output data may concern the entity per se (for example, the output data may comprise a property of the entity per se) without reference to a specific instance of the entity within the digital representation of a document.

In a preferred embodiment, the annotation relation data concerns specific instances of a relation within the digital representation of a document, but the output relation data concerns the relation per se. For example, there might be four references to a relation between two proteins in a digital representation of a document (perhaps using more than one synonym of the protein), but the output data may concern the relation per se (for example, the output data may comprise a property of the relation between the two proteins per se) without reference to a specific instance of the relation within the digital representation of a document.

Where the document comprises biomedical information, the entities may comprise chemical species, oligonucleotides, oligopeptides, oligosaccharides, polynucleotides, polypeptides or polysaccharides, biochemical macromolecules, such as proteins or nucleic acids, subcellular components, such as organelles, cells, viruses or multicellular organisms. The entity may be a part of a larger entity, (e.g. a domain of a protein), or a combination of entities (e.g. a protein complex).

The entity identifier may be an alias of an identifier of the entity in the database which is to be populated with the data (e.g. an accession number of the entity in the database which is to be populated with data). The entity identifier may be resolvable to an identifier of the entity in the database and the method may comprise the step of resolving the entity identifier to determine an identifier of a corresponding entity in the database which is to be populated with data.

Preferably, the entity identifier is a reference to data, within ontology data, which concerns a particular entity. Preferably, the ontology data comprises synonyms of entities. The ontology data typically comprises normalised forms of entities. The method may comprise the step of retrieving a normalised synonym of an entity from ontology data using the entity identifier and including that normalised synonym of the entity in the data with which the database is populated. One skilled in the art will appreciate that the normalised synonym of an entity is a matter of choice and may be different in different ontologies.

The annotation relation data, and optionally the output relation data, preferably comprises identifiers of entities between which a relation has been identified, and may simply consist of identifiers of entities between which a relation has been identified. The identifiers could be identifiers of specific instances of entities (e.g. a code denoting a particular word which denotes an entity) within the digital representation of a document. Alternatively, they could be identifiers of entities which do not relate to a specific mention of an entity (e.g. a code denoting a particular protein).

The annotation relation data, and optionally the output relation data, may comprise the location of an instance of a relation within the text. For example, the annotation relation data and/or the output relation data may comprise an identifier of a character within the digital representation of a document where text relating to an instance of a relation begins, and also an identifier of a character within the digital representation of a document where text relating to an instance of a relation ends. However, it may be the case that the annotation relation data, and optionally the output relation data does not comprise the location of an instance of a relation. In some embodiments, the annotation relation data comprises the location of one or more instances of a relation, but the output relation data does not.

In a preferred embodiment, the annotation relation data comprises identifiers of particular instances of entities within the digital representation of a document. As the location of identified instances of entities is stored, the location of a relation could be considered as extending from one entity to another.

The annotation relation data may comprise identifiers of entities (for example, an identifier of an entity may be a reference to ontology data which comprises synonyms of entities). Preferably, the annotation relation data comprises identifiers of specific instances of entities, for example, a character offset or word identifier.

Typically, the relation between entities is a binary relation between two entities, although the relation between entities may be a relation between two or more entities. The relation between entities may be a technical relation. For example, where the entities are proteins, the relation may be a proven or hypothesized technical relation between proteins. For example, the relation may be that a protein interacts with another protein.

A relation may be directional, for example, annotation relation data and/or output relation data may specify the direction of an interaction (e.g. that a first protein acted on a second protein).

A relation may be hypothetical. A relation may be proposed. A relation may be explicitly stated in a document. A relation may be implied by a document. A relation may be a negative fact or hypothesis, for example, that two entities do not interact or that a document does not support a conclusion.

The annotation relation data, and optionally, the output relation data, may comprise the location of a relation within the digital representation of a document. The annotation relation data, and optionally the output relation data, may comprise a location within the digital representation of a document where text specifying that relation begins and ends. The location may be implied by the annotation relation data, and optionally the output relation data, specifying identifiers of two or more entities and the annotation data comprising data specifying, the location of two or more identified instances of entities. It may be that the annotation relation data comprises the location of one or more relations within the digital representation of a document but the output data does not comprise the location of one or more relations within the digital representation of a document.

Where the method includes the step of displaying data concerning at least some of any identified relations, and the annotation data comprises the location of the said relations within the digital representation of the document, or data from which the location of the said relations within the digital representation of the document can be derived, the at least some of any identified relations may be displayed at the location within the digital representation of a document which has been stored as annotation data.

Preferably, the annotation relation data and/or the output relation data comprises fragments of text identifying the entities which the relation concerns. The fragments of text may correspond to fragments of the digital representation of a document. However, the fragments of text may comprise normalised forms of the entities which the relation concerns. The method may include the step of determining a normalised form of one or more entities which a relation concerns, with reference to the ontology data, and including that normalised form in the output relation data and/or the annotation relation data and/or the provisional amended annotation relation data.

The annotation entity data specifying the location of an identified instance of an entity within the digital representation of the document may comprise the location of the identified instance of an entity within the digital representation of the document (e.g. the data may comprise a number associated with the character where the instance of an entity starts, or a number which has been allocated to the particular word denoting the instance of the entity). However, the data specifying the location of the identified instance of an entity within the digital representation of the document may comprise data from which the location of the identified instance of an entity within the digital representation of the document may be calculated. Preferably, some or all of the entity data (for example, the identifier of an entity) is embedded inline within the digital representation of the document and it is the location of the entity data within the digital representation of the document which specifies the location of the entity within the digital representation of the document.

The digital representation of the document may comprise the annotation data. In a preferred embodiment, the digital representation of a document and the annotation data comprise or consist of data stored in the form of a file in a markup language with annotation data being stored in the form of tagged values within the file. For example, the digital representation of a document may be stored in the form of an XML file, the format of which corresponds to an XML standard as issued from time to time by the world wide web consortium (see www.w3.org/xml), for example, XML 1.0 or XML 1.1, with the annotation data included therein as tagged values.

Annotation relation data may be stored inline within a digital representation of the document, but preferably annotation relation data is stored in the form of standoff annotation, either within the same file as the digital representation of the document, or as a separate file.

Amended annotation data may be prepared by amending stored annotation data. The amended annotation data may be amended by storing different annotation data and using the different annotation data. Amended annotation data may be prepared by amending provisional annotation data derived initially from the annotation data.

The digital representation of a document preferably comprises data representing text. Preferably, the document comprises text. The digital representation of a document preferably comprises characters, where characters are units of information used for the organization, control, or representation of textual data. The digital representation of a document may comprise characters according to a recognised international character repertoire such as ASCII, ISO 646, or ISO/IEC 10646 (Unicode).

The document may be a text document, such as an academic paper, patent document, book chapter or book. However, the document may comprise images or speech. The document may be a printed document, such as a document published in a printed book or paper. The document may be in an electronic format, for example, the document may be published electronically, for example as a Portable Document Format (PDF) file. If the document is in an electronic format then the digital representation of the document may be the document, a copy of the document or a plain text representation of the document. However, the digital representation of the document is generally derived from the document. For example, a printed document may be scanned and analysed by optical character recognition software.

The digital representation of the document may comprise a representation of only part of the document. The digital representation may omit some features of the document, for example, one or more of images, superscripts, subscripts, page numbers, page titles etc. which are included in the document. The digital representation of the document may be obtained by electronic analysis of a document. The method may comprise the step of analysing a document to prepare the digital representation of a document. Preferably, the digital representation of a document is not prepared by removing mark-up from an XML file.

The document identifier preferably identifies the document. For example, the document identifier may comprise a reference to a scientific paper, or an identification code or accession numbers such as a Pubmed ID. However, the document identifier may also or instead identify the digital representation of the document, for example the document identifier may be an identifier of a digital representation of a document within a private collection of digital representations of documents. The annotation data may comprise a document identifier of a document and a document identifier of the digital representation of a document. The document identifier may identify part of the document, for example, the abstract of a document. Different parts of the same document (or digital representations thereof) may have different document identifiers. For example, the document identifier for the abstract of a document may be different to the document identifier for the body of the text of a document. The document identifier may comprise an identifier of a collection of documents.

The document may be a technical document, such as a scientific paper, technical description, or a record of an experiment. The document may comprise information relating to a specific technical field, for example one or more of biomedical information, astrophysical information, geographical information, geophysical information, mathematical information, engineering information, or physical sciences information, in any combination. The document may be a patent publication or comprise patent information. The method may be repeated with further documents from the same technical field to populate a database with data concerning one or more of the said technical fields, in any combination.

The method may include the step of retrieving digital representations of documents fulfilling one or more criteria. The annotation data may comprise some or all of the said criteria and the method may comprise the step of storing some or all of the said criteria in the annotation data. The method may include the step of storing the digital representation of a document in the form in which it was originally retrieved and providing means for the user of the user-interface means to display the original digital representation of a document.

The database is preferably a relational database although the database may be any type of database, for example an object-oriented database, an object-relational database or a flat-file database.

The database preferably comprises some, or preferably all, of data concerning entities, data concerning properties of entities, data concerning relations between entities and data concerning properties of relations between entities.

The computer-user interface means preferably comprises a display, such as a computer monitor with user-interface components displayed thereon. The computer-user interface means preferably comprises means for providing instructions, such as a keyboard and/or a pointing device (such as a computer mouse).

Instances of entities may be highlighted at the location within the digital representation of a document which is specified by annotation entity data by presenting the instance of the entity differently to surrounding text (for example, in a different colour, style and/or font). Instances of entities may be highlighted at the location within the digital representation of a document specified by annotation entity data by displaying them on a different background colour to surrounding text.

Instances of relations may be highlighted at the location within the digital representation of a document which is specified by annotation relation data by displaying the instance of the relation differently to surrounding text (for example, in a different colour, style and/or font). Instances of relations may be highlighted at the location within the digital representation of a document specified by annotation relation data by displaying them on a different background colour to surrounding text.

Instances of relations may however be displayed to a user of computer-user interface means other than at a location within the digital representation of the document which describes that relation.

The computer-user interface means may comprise means for enabling a user to select one or more instances of entities and to selectively display at least part of the digital representation of a document with the said selected instances of entities being highlighted differently to other instances of entities or the only highlighted instance of an entity.

The computer-user interface means may comprise means for enabling a user to select one or more instances of relations and to selectively display at least part of the digital representation of a document with the said selected instances of relations being highlighted differently to other instances of relations or the only highlighted instance of a relation.

The computer-user interface means may comprise means for amending the annotation data responsive to instructions received from a user of the computer-user interface means, which amendments do not result in an amendment to what is displayed to a user. For example, the computer-user interface means may be adapted to allow a user to amend tokenisation, but this may not affect the display.

The computer-user interface means may be adapted to allow a user to select whether the database is to be populated with output data concerning a particular relation, and the step of populating the database with output data include the step of populating the database with data concerning only one or more relations which were selected. Preferably, the computer-user interface means is adapted to allow a user to select whether the database is to be populated with output data concerning a particular instance of a relation.

The computer-user interface means may be adapted to allow a user to select whether the database is to be populated with data concerning a particular entity, and the step of populating the database with output data include the step of determining whether to populate the database with data concerning selected entities. Preferably, the computer-user interface means is adapted to allow a user to select whether the database is to be populated with output data concerning a particular instance of an entity.

The computer-user interface means may be adapted to allow a user to positively select an entity for output and, where an entity has been selected by a user for output, data concerning that entity is stored in the database.

For example, the computer-user interface means may comprise a user-interface item (for example, a check box) which can be selected (for example, checked) to indicate that the database is to be populated with output data concerning an entity derived from annotation entity data concerning a particular instance of an entity.

The computer-user interface means may be adapted to allow a user to positively select a relation for output and, where a relation has been selected by a user for output, data concerning that relation is stored in the database.

For example, the computer-user interface means may comprise a user-interface item (for example, a check box) which can be selected (for example, checked) to indicate that the database is to be populated with output data concerning a relation derived from annotation relation data concerning a particular instances of a relation.

The computer-user interface means may be adapted to allow a user to positively select a document for output, and, where a document has been selected for output by a user, data concerning all entities and/or relations referred to in that document in respect of which annotation data has been stored, is stored in the database. Alternatively, where a document has been selected for output by a user, that document might be output without further data concerning the entities and/or relations referred to in that document.

The computer-user interface means may be adapted to allow a user to reject a document and, where a document has been rejected by a user, data concerning entities and/or relations identified in that document is not stored in the database.

Preferably, the method also includes the step of storing the amended annotation data or outputting the amended annotation data for storage. The annotation data can therefore be reviewed at a later stage or used for other purposes. Where the digital representation of the document comprises annotation data, the amended annotation data may be stored, or output as output data, by storing a file comprising both a digital representation of the document and that annotation data (e.g. as an XML file).

The ontology data may comprise a normalised form of an entity. A or each reference to ontology data may comprise a reference to a normalised form of an entity in the ontology data. The ontology data may be a hierarchical data structure specifying entities and relationships between those entities. The ontology data may be indexed by a field which identifies a normalised form of an entity and/or one or more synonyms of an entity. The ontology data may be stored in an ontology database. The ontology data may be stored in the database which is to be populated. The ontology data may be derived from the database which is to be populated.

The ontology data may further comprise attributes of relations.

Data concerning entities and/or relations in the database may be stored with reference to the ontology data. However, data concerning entities and/or relations in the database could be stored with reference to second ontology data and the step of populating the database may include the step of translating references to ontology data to refer to the second ontology data. The step of translating references to ontology data typically comprises translating identifiers of entities.

The computer-user interface means may be adapted to enable a user to amend the ontology data. The method may comprise the step of amending the ontology data responsive to instructions received through a user of the computer-user interface means.

The computer-user interface means may be adapted to enable a user to cause data concerning an entity to be added to the ontology data. The method may comprise the step of adding ontology data concerning an entity to the ontology data responsive to instructions received through a user of the computer-user interface means.

The computer-user interface means may be adapted to enable a user to cause data concerning a relation to be added to the ontology data. The method may comprise the step of adding ontology data concerning a relation to the ontology data responsive to instructions received through a user of the computer-user interface means.

Preferably, the method further comprises the step of using the ontology data which has been amended (or amendable) responsive to instructions received by the user of computer-user interface means for the analysis of further digital representations of documents.

Preferably, the analysis of a digital representation of a document is carried out by trainable information extraction module which is trainable using training data which comprises digital representations of documents and annotation data comprising the location of instances of entities (optionally and/or relations) in the documents and identifiers of the identified entities (optionally and/or relations), and the computer-user interface means is adapted to allow an analysed digital representation of a document and annotation data relating to entities (optionally and/or relations) referred to in the digital representation of the document to be selected by a user for use as training data for training the trainable information extraction module, and the method further includes the step of retraining the trainable information extraction module using data comprising the selected training data and using the retained trainable information extraction module in the analysis of further documents.

Preferably, the step of analysing the digital representation of a document comprises the steps of tokenisation (carried out by a tokenisation software module), named entity recognition (carried out by a named entity recognition software module) and term normalisation (carried out by a term normalisation module). The step of analysing the digital representation of a document preferably further comprises the step of relation extraction.

The step of term normalisation is preferably carried out with reference to the ontology data. The step of term normalisation preferably includes the step of storing annotation entity data comprising identifiers of instances of one or more entities which have been identified in the digital representation of a document wherein the identifiers of instances of entities are identifiers of entities in ontology data.

Typically, the trainable information extraction module comprises the named entity recognition software module. The named entity recognition software may be trainable using selected training data comprises curated, annotated digital representations of documents. The named entity recognition software module preferably uses a maximum entropy algorithm trained on training data comprising the selected training data.

Preferably, the computer-user interface means is adapted to allow a user to select a batch of digital representations of documents for analysis and then to sequentially and/or simultaneously display the batch of digital representations of documents and amend annotation data concerning the batch of digital representations of documents. A batch of digital representations of documents may fulfil the same search criteria. The batch of digital representations of documents may have been retrieved responsive to a single search request.

According to a fourth aspect of the present invention, there is provided a method of populating a second database, the method comprising the steps of populating a first database by the method of the first, second or third aspect of the present invention, and exporting some or all of the data used to populate the first database from the first database to the second database.

The first and second databases may be in a different format and the step of exporting some or all of the said data may comprise the step of translating the format of the exported data.

The identifiers of entities (and/or relations) in the first database may refer to first ontology data and the identifier of entities (and/or relations) in the second database may refer to second ontology data and the step of exporting some or all of the said data may comprise the step of translating references to the first ontology data to references to the second ontology data.

The method may include the step of importing ontology data from the second ontology data into the first ontology data, converting the format of the ontology data if required, and using the imported ontology data during the analysis of further documents.

The method may comprise the step of populating a plurality of second databases, at least two of which comprise different ontology data and/or different identifiers of entities. At least two of the plurality of second databases may be in different formats and/or the ontology data which is referred to by identifiers stored in at least two of the plurality of second databases may be in different formats.

The method may further comprise the step of creating a further database by including within that database some or all of the output data with which the database was populated by the method of any one of the first four aspects of the invention, translating or converting that data into another format if need be.

According to a fifth aspect of the present invention there is provided a database populated according to the method of any one of the second, third or fourth aspects of the invention.

According to a sixth aspect of the present invention, there is provided a method of outputting data responsive to a search request, comprising the steps of populating a database using the method of the second, third or fourth aspects of the invention, receiving a search request, querying the database to retrieve data relevant to the search request and outputting the retrieved data.

The method may include the step of retrieving one or more digital representations of a document responsive to a search request, subsequently populating the database using the method of the second, third or fourth aspects of the invention, and subsequently outputting data comprising data concerning the said retrieved digital representations of documents.

The method may include the step of logging search requests and selecting further digital representations of documents for subsequent analysis, or retrieving further digital representations of documents which fulfil one or more said search requests for subsequent analysis.

The method may further comprise the step of including the retrieved data, or data derived from the retrieved data, within a file (such as a web page) and transmitting that file responsive to the search request.

According to a seventh aspect of the present invention, there is provided a method of creating or amending an ontology database comprising ontology data, comprising the steps carried out by computing apparatus of:
(i) receiving as input data a digital representation of a document;
(ii) analysing the digital representation of a document, identifying one or more instances of entities contained in the digital representation of the document and, for at least some of the identified instances of entities, storing annotation data comprising annotation entity data concerning one or more instances of entities which have been identified in the digital representation of a document, the annotation entity data comprising identifiers of instances of one or more entities which have been identified in the digital representation of a document and data specifying the location of the identified instances of entities within the digital representation of a document, wherein the identifiers of entities comprise references to the ontology data;
(iii) displaying at least part of the digital representation of a document to a user of computer-user interface means, with annotations dependent on the annotation data, the said annotations including at least highlighting one or more of the instances of entities whose location is specified in the annotation entity data at the location within the digital representation of a document specified by the annotation entity data;
(iv) providing the user of computer-user interface means with means to amend the ontology data;
(v) preparing amended annotation data responsive to instructions received from a user of the computer-user interface means; and
(vi) amending the ontology data responsive to instructions received by a user of the computer-user interface means.

The step of amending the ontology data may comprise one or more of deleting ontology data, adding ontology data or amending ontology data. Steps (iv) to (vi) may take place in any order or concurrently.

The ontology data may comprise a normalised form of an entity. The ontology data may be a hierarchical data structure specifying entities and relationships between those entities. The ontology data may be indexed by a field which identifies a normalised form of an entity and/or one or more synonyms of an entity. The ontology data may comprise ontology data concerning relations.

The method may further comprise the step of creating an ontology database by including within that database some or all of the ontology data created or amended by the method of the present invention, optionally converting the format of that ontology data if need be.

The method may further comprise the step of outputting output data derived from the amended annotation data and/or populating a database with output data derived from the amended annotation data. Preferred and optional features correspond to those discussed in relation to the first, second and third aspects of the invention.

According to a eighth aspect of the present invention, there is provided ontology data obtained by the method of the seventh aspect of the present invention.

According to a ninth aspect of the present invention, there is provided a method of training a trainable information extraction module, comprising the steps carried out by computing apparatus of:
(i) receiving as input data a digital representation of a document;
(ii) analysing the digital representation of a document using the trainable information extraction module, the trainable information extraction module identifying one or more instances of entities contained in the digital representation of the document and, for at least some of the identified instances of entities, storing annotation data comprising annotation entity data concerning one or more instances of entities which have been identified in the digital representation of a document, the annotation entity data comprising identifiers of instances of one or more entities which have been identified in the digital representation of a document and data specifying the location of the identified instances of entities within the digital representation of a document, wherein the identifiers of entities comprise references to ontology data;
(iii) displaying at least part of the digital representation of a document to a user of computer-user interface means, with annotations dependent on the annotation data, the said annotations including at least highlighting one or more of the instances of entities whose location is specified in the annotation entity data at the location within the digital representation of a document specified by the annotation entity data;
(iv) preparing amended annotation data responsive to instructions received from a user of the computer-user interface means;
(v) providing a user of the computer-user interface means with means to select a digital representation of a document for use in training the trainable information extraction module; and
(vi) periodically retraining the trainable information extraction module using training data comprising at least part of the selected digital representation of a document and the amended annotation data which concerns the selected digital representation of a document.

The user-interface means may be adapted to enable a user to select a portion of the digital representation of a document for use in retraining the information extraction module and that portion of the digital representation of a document may be used for retraining the information extraction module. Typically, the information extraction module will be retrained using only annotation data which has been received and, where required, amended by a curator. Steps (iii) to (v) may take place simultaneously or concurrently.

The trainable information extraction module may comprise a tokenisation module, a named entity recognition module, a term normalisation module and a relation extraction module. Typically, only the named entity recognition module is trainable, however other modules within the trainable information extraction module may be trainable.

The method may further comprise the step of outputting output data derived from the amended annotation data and/or populating a database with output data derived from the amended annotation data. Preferred and optional features correspond to those discussed in relation to the first, second and third aspects of the invention.

In a tenth aspect, the invention provides an information extraction module trained by the method of the ninth aspect of the present invention.

The invention extends in an eleventh aspect to a system for editing annotation data associated with a digital representation of a document, the system comprising computer-user interface means (such as a computer-user interface) and output means (such as an output module);
wherein the computer-user interface means is operable to receive as input data a digital representation of a document and annotation data, the annotation data comprising annotation entity data concerning one or more instances of entities which have been identified in the digital representation of a document, the annotation entity data comprising identifiers of instances of one or more entities which have been identified in the digital representation of a document and data specifying the location of the identified instances of entities within the digital representation of a document, wherein the identifiers of instances of entities comprise references to ontology data;
and wherein the computer-user interface means is operable to display at least part of the digital representation of a document to a user of the computer-user interface means, with annotations dependent on the annotation data, the said annotations including at least highlighting one or more of the instances of entities whose location is specified in the annotation entity data at the location within the digital representation of a document specified by the annotation entity data;
and wherein the computer-user interface means is operable to receive instructions from a user of the computer-user interface means and to prepare amended annotation data responsive to the received instructions;
and wherein the output means is operable to output data derived from the amended annotation data.

Preferred and optional features of the system and the data which the system is adapted to process correspond to those discussed in relation to the first, second and third aspects of the present invention.

The invention extends in a twelfth aspect to a system for populating a database, the system comprising computer-user interface means (such as a computer-user interface) and output means (such as an output module);
wherein the computer-user interface means is operable to receive as input data a digital representation of a document and annotation data, the annotation data comprising annotation entity data concerning one or more instances of entities which have been identified in the digital representation of a document, the annotation entity data comprising identifiers of instances of one or more entities which have been identified in the digital representation of a document and data specifying the location of the identified instances of entities within the digital representation of a document, wherein the identifiers of instances of entities comprise references to ontology data;
and wherein the computer-user interface means is operable to display at least part of the digital representation of a document to a user of the computer-user interface means, with annotations dependent on the annotation data, the said annotations including at least highlighting one or more of the instances of entities whose location is specified in the annotation entity data at the location within the digital representation of a document specified by the annotation entity data;
and wherein the computer-user interface means is operable to receive instructions from a user of the computer-user interface means and to prepare amended annotation data responsive to the received instructions;
and wherein the output means is operable to populate the database with output data derived from the amended annotation data.

Preferably, the system further comprises analysis means (such as an analysis module) operable to analyse the digital representation of a document.

Preferred and optional features of the system and the data which the system is adapted to process correspond to those discussed in relation to the first, second and third aspects of the invention.

In a thirteenth aspect, the invention extends to a system for populating a database, the system comprising analysis means (such as an analysis module), computer-user interface means (such as a computer-user interface) and output means (such as an output module);
wherein the analysis means is operable to receive as input data a digital representation of a document and to analyse the digital representation of a document, identify one or more instances of entities contained in the digital representation of the document and, for at least some of the identified instances of entities, store annotation data comprising annotation entity data concerning one or more instances of entities which have been identified in the digital representation of a document, the annotation entity data comprising identifiers of instances of one or more entities which have been identified in the digital representation of a document and data specifying the location of the identified instances of entities within the digital representation of a document, wherein the identifiers of entities comprise references to ontology data;
wherein the computer-user interface means is operable to receive as input data a digital representation of a document and the annotation data stored by the analysis means and to display at least part of the digital representation of a document to a user of the computer-user interface means, with annotations dependent on the annotation data, the said annotations including at least highlighting one or more of the instances of entities whose location is specified in the annotation entity data at the location within the digital representation of a document specified by the annotation entity data;
wherein the computer-user interface means is operable to receive instructions from a user of the computer-user interface means and to prepare amended annotation data responsive to the received instructions;
and wherein the output means is operable to populate the database with output data derived from the amended annotation data.

Preferred and optional features of the system and the data which the system is adapted to process correspond to the preferred and optional features of the first, second and third aspects of the invention.

According to a fourteenth aspect of the present invention, there is provided a system for creating or amending an ontology database comprising ontology data, the system comprising analysis means (such as an analysis module), computer-user interface means (such as a computer-user interface) and output means (such as an output module);
wherein the analysis means is operable to receive as input data a digital representation of a document and to analyse the digital representation of a document, identify one or more instances of entities contained in the digital representation of the document and, for at least some of the identified instances of entities, store annotation data comprising annotation entity data concerning one or more instances of entities which have been identified in the digital representation of a document, the annotation entity data comprising identifiers of instances of one or more entities which have been identified in the digital representation of a document and data specifying the location of the identified instances of entities within the digital representation of a document, wherein the identifiers of entities comprise references to the ontology data;
wherein the computer-user interface means is operable to receive as input data a digital representation of a document and the annotation data stored by the analysis means and to display at least part of the digital representation of a document to a user of the computer-user interface means, with annotations dependent on the annotation data, the said annotations including at least highlighting one or more of the instances of entities whose location is specified in the annotation entity data at the location within the digital representation of a document specified by the annotation entity data;
wherein the computer-user interface means is operable to receive instructions from a user of the computer-user interface means and to prepare amended annotation data responsive to the received instructions;
wherein the computer-user interface means is operable to receive instructions from a user of the computer-user interface means to amend the ontology data and to amend the ontology data responsive to the received instructions;
and wherein the output means is operable to populate the database with output data derived from the amended annotation data.

Preferred and optional features of the system and the data which the system is adapted to process correspond to the preferred and optional features discussed in relation to the seventh aspect of the invention.

According to a fifteenth aspect, the invention extends to a system for training a trainable information extraction module, the system comprising analysis means (such as an analysis module), computer-user interface means (such as a computer-user interface) and output means (such as an output module);
wherein the analysis means comprises a trainable information extraction module which is operable to receive as input data a digital representation of a document and to analyse the digital representation of a document, identify one or more instances of entities contained in the digital representation of the document and, for at least some of the identified instances of entities, store annotation data comprising annotation entity data concerning one or more instances of entities which have been identified in the digital representation of a document, the annotation entity data comprising identifiers of instances of one or more entities which have been identified in the digital representation of a document and data specifying the location of the identified instances of entities within the digital representation of a document, wherein the identifiers of entities comprise references to ontology data;
wherein the computer-user interface means is operable to receive as input data a digital representation of a document and the annotation data stored by the analysis means and to display at least part of the digital representation of a document to a user of the computer-user interface means, with annotations dependent on the annotation data, the said annotations including at least highlighting one or more of the instances of entities whose location is specified in the annotation entity data at the location within the digital representation of a document specified by the annotation entity data;
wherein the computer-user interface means is operable to receive instructions from a user of the computer-user interface means and to prepare amended annotation data responsive to the received instructions;
wherein the computer-user interface means comprises means for a user to select a digital representation of a document for use in training the trainable information extraction module;
wherein the output means is operable to populate the database with output data derived from the amended annotation data;
and wherein the system is operable to periodically retrain the trainable information extraction module using training data comprising at least part of the selected digital representation of a document and the amended annotation data which concerns the selected digital representation of a document.

Preferred and optional features of the system and the data which the system is adapted to process correspond to the preferred and optional features discussed in relation to the ninth aspect of the invention.

Although the embodiments of the invention described with reference to the drawings comprise methods performed by computer apparatus, and also computing apparatus, the invention also extends to program instructions, particularly program instructions on or in a carrier, adapted for carrying out the processes of the invention or for causing a computer to perform as the computer apparatus of the invention. Programs may be in the form of source code, object code, a code intermediate source, such as in partially compiled form, or any other form suitable for use in the implementation of the processes according to the invention. The carrier may be any entity or device capable of carrying the program instructions.

For example, the carrier may comprise a storage medium, such as a ROM, for example a CD ROM or a semiconductor ROM, or a magnetic recording medium, for example a floppy disc or hard disc. Further, the carrier may be a transmissible carrier such as an electrical or optical signal which may be conveyed via electrical or optical cable or by radio or other means. When a program is embodied in a signal which may be conveyed directly by cable, the carrier may be constituted by such cable or other device or means.

The preferred and optional features discussed above are preferred and optional features of each aspect of the invention to which they are applicable. For the avoidance of doubt, the preferred and optional features of the first and second aspects of the invention correspond to the preferred and optional features discussed in relation to the third aspect of the invention, where applicable.

### BRIEF DESCRIPTION OF THE DRAWINGS

The invention will be further described, by way of example only, with reference to the following drawings in which:

FIG. 1 is a schematic diagram of the main flow of information through a system according to the present invention;

FIG. 2 is a schematic diagram of key components of the system;

FIG. 3 is a schematic diagram of layers within the system architecture;

FIG. 4 is a flow diagram of the steps involved in retrieving documents files and filtering them prior to information extraction;

FIG. 5 is a flow diagram of the steps involved in information extraction;

FIG. 6 is an example text suitable for analysis by the system;

FIG. 7 is an XML file concerning the example text before information extraction;

FIGS. 8A, 8B, 8C and 8D constitute successive portions of an XML file concerning the example text after information extraction;

FIG. 9 is the text of FIG. 6 with identified entities underlined and identified relations labelled;

FIG. 10 is a schematic diagram of a curation user interface;

FIG. 11 is a schematic diagram of an ontology data feedback loop;

FIG. 12 is a schematic diagram of an ontology data maintenance system; and

FIG. 13 is a schematic diagram of the feedback of training data within the system.

### DETAILED DESCRIPTION OF AN EXAMPLE EMBODIMENT

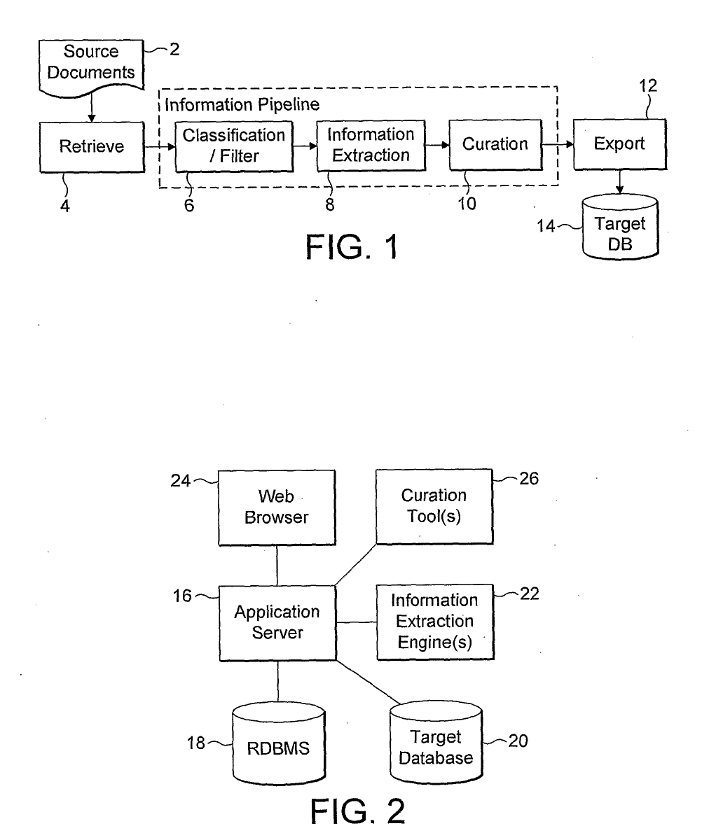

By way of introduction, FIG. 1 is a schematic diagram of the main flow of information through a system according to the present invention. Source documents 2 are retrieved 4 from a document source. The system analyses digital representations of documents and so the source documents will typically be digital representations of documents, for example, full text journal articles or Medline Abstracts, (Medline is a trade mark of the National Library of Medicine, Bethesda, Md.), although the documents may be retrieved in printed form and scanned. Document files (which constitute digital representations of documents) are then classified and filtered 6 before being subject to an information extraction procedure 8 using natural language processing (NLP) methods before being curated 10 by a human curator using a user interface. Following the curation step, data is exported 12 to a target database 14. The flow of information through the system is discussed in more depth below.

FIG. 2 is a schematic diagram of key components of the system. Application logic running on an application server 16 controls the system via a set of core services running in a J2EE application server (J2EE is a trade mark of Sun Microsystems) using a Spring Framework container (The Spring Framework is an open source project described at www.springframework.org). Relevant data, such as document files (constituting digital representations of documents) is retrievably stored in the form of XML files by a relational database management system 18. Information extraction engine(s) 22 are implemented by a single processor or one or more processors operating in parallel. A web browser 24 provides administrative access to the system and control over the curation process. Curation tools 26 implement a computer-user interface on computers, each of which has a display, keyboard and a pointing device such as a mouse. Individual components can be connected through a network. The application server will typically communicate with web browsers and curation tools over SOAP and HTTP though an internet protocol network. One skilled in the art will recognise that several components of the system can be implemented on a single computer, or individual components may be implemented on a single computer or a cluster of computers.

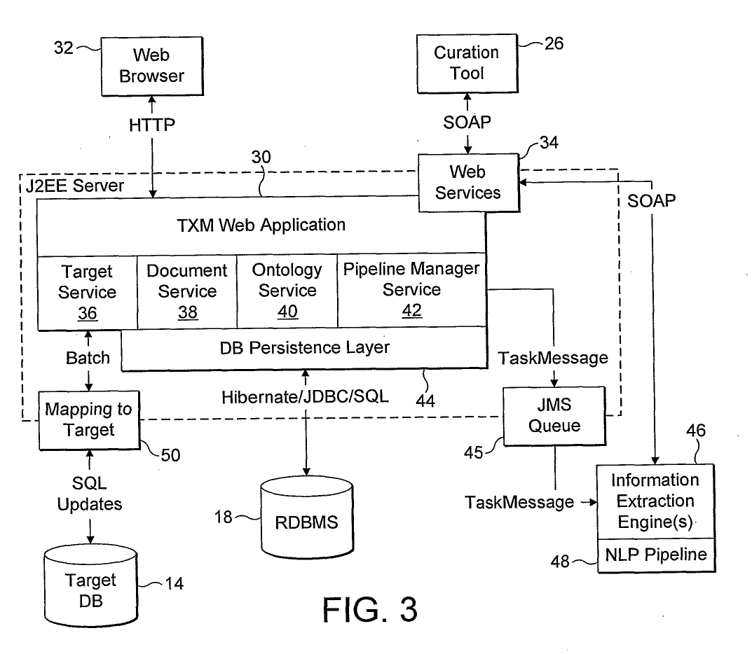

The software components which make up the system can be described in the form of layers, illustrated schematically in FIG. 3. Presentation logic is encapsulated in web application layer 30, allowing control of the system via a web browser 32. Web services components 34 communicate with one or more curation tools 26 delivered to web browsers as Java applications using Java Web Start. (Java and Java Web Start are trade marks of Sun Microsystems).

Key aspects of the application logic are encapsulated in four key services, namely a target service 36 which includes control logic relating to bidirectional communication with a target database 14, including logic relating to the export of output data for populating a target database; a document service 38 which serves as an API to collections of document files which have been gathered and stored, allowing other components of the system read/write access to the data in an abstracted and controlled fashion; an ontology service 40 which manages a persistent representation of the ontologies used within the system and also manages export of ontology data in a format suitable for use by the information extraction engine as well as import of ontology data from the target database; and a pipeline manager service 42 which comprises a web tier providing a user interface adapted to allow the initiation and monitoring of curation jobs and a service layer which encapsulates the core functionality for handling curation jobs. A database persistence layer 44 provides control logic to allow data to be persisted uniformly to the relational database management system 18 using the Hibernate object/relational persistence and query service or customised SQL via JDBC (JDBC is a trade mark of Sun Microsystems, Inc. Hibernate is an open source project described at www.hibernate.org). Information extraction is decoupled via a JMS queue 45 and managed by information extraction engine 46 which interfaces with natural language processing (NLP) pipeline 48. Another important part of the system is a target mapping control module 50 which maps output data from the target service to a target database.

### Document Retrieval

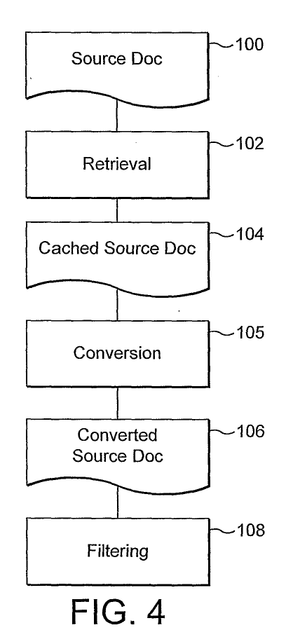

In use, document files are retrieved from external sources under the control of the pipeline manager service. FIG. 4 is a flow diagram of the steps involved in retrieving documents files and filtering them prior to information extraction. Document files 100 are retrieved 102 from one or more remote sources and cached 104. Document files may be received which fulfil a particular search query, or according to predetermined criteria. For example, documents fulfilling certain criteria may be automatically retrieved periodically from PubMed (www.ncbi.nlm.nih.gov/entrez/query.fcgi).

Document files are then converted 105 into a different format if need be. Document files are converted into XML files including plain text with no, or relatively little mark-up. A software module is provided for converting document files in portable document format (PDF) to XML. It is important that these document files are not XML marked-up files which have simply had the XML mark-up removed. This is because text obtained by removing mark-up from a marked up XML source will not always be the same as that obtained directly from an original plain text source. For example, an XML marked-up document might annotate a protein fragment using subscripts or superscripts to identify the particular fragment. For example, if the XML mark-up was removed from XML mark-up denoting text fragment ABC¹²⁻³⁷, the resulting plain text would be ABC12-37. However, the same document from an original plain text source may mark this up as ABC12-37 or ABC 12-37 or ABC(12-37) or ABC[12-37].

The converted document files are stored 106 and both the original retrieved document files and the converted document files are retained in storage. Document files (which have been converted if need be) are optionally filtered 108 to determine those of most relevance.

### Information Extraction

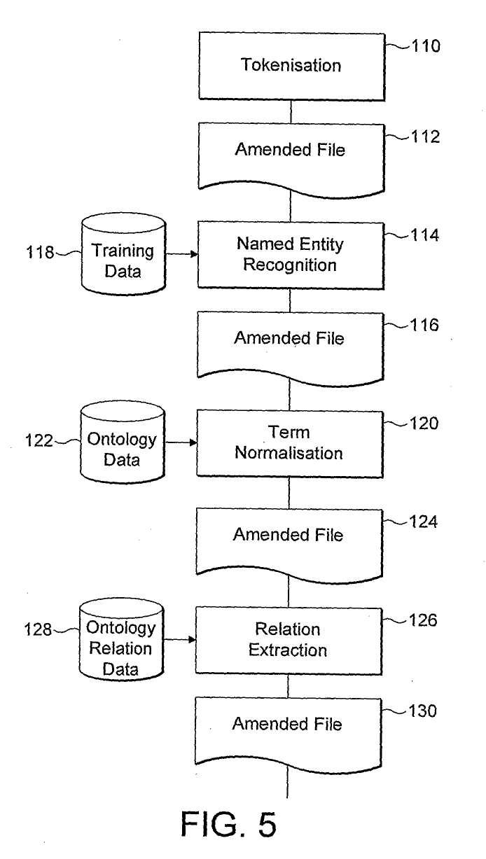

FIG. 5 is a flow diagram of the steps involved in the subsequent information extraction procedure. A tokenisation software module 110 accepts a cached document file in XML format as input and outputs an amended XML file 112 including tokenisation mark-up. A named entity recognition software module 114 receives the amended XML file 112 as input and outputs a further amended XML file 116 in which individual instances of entities have been recognised and marked-up. The named entity recognition software module 114 has been previously trained on training data 118. Training data 118 is described further below. The amended XML file 116 is then processed by a term normalisation software module 120 which also takes ontology data 122 as an input, outputting a further amended XML file 124 in which individual instances of entities have been labelled by reference to normalised forms of the entity stored in the ontology data. The amended XML file 124 is then processed by a relation extraction software module 126 which outputs an annotated XML file 128 including data concerning relations which have been identified in the document file.

Tokenisation, named entity recognition, term normalisation and relation extraction are each significant areas of ongoing research and software for carrying out each of these stages is well known to those skilled in the field of natural language processing. In an exemplary information extraction pipeline, input documents in a variety of formats, such as pdf and plain text, as well as XML formats such as the NCPI/NLM archiving and interchange DTD, are converted to a simple XML format which preserves some useful elements of a document structure and formatting information, such as information concerning superscripts and subscripts, which can be significant in the names of proteins and other biomedical entities. Documents are assumed to be divided into paragraphs, represented in XML by <p> elements. After tokenisation, using the default tokeniser from the LUCENE project (the Apache Software Foundation, Apache Lucene, 2005) and sentence boundary detection, the text in the paragraphs consists of <s> (sentence) elements containing <w> (word) elements. This format persists throughout the pipeline. Additional information and annotation data added during processing is generally recorded either by adding attributes to words (for example, part-of-speech tags) or by standoff mark-up. The standoff mark-up consists of elements pointing to other elements by means of ID and IDREF attributes. This allows overlapping parts of the text to be referred to, and standoff elements can refer to other standoff elements that are not necessarily contiguous in the original text. Named entities are represented by <ent> elements pointing to the start and end words of the entity. Relations are represented by a <relation> element with <argument> children pointing to the <ent> elements participating in the relation. The standoff mark-up is stored within the same file as the data, so that it can be easily passed through the pipeline as a unit, but one skilled in the art will recognise that the mark-up may be stored in other documents.

Input documents are then analysed in turn by a sequence of rule-based pre-processing steps implemented using the LT-TTT2 tools (Grover, C., Tobin, R. and Matthews, M., Tools to Address the Interdependence between Tokenisation and Standoff Annotation, in Proceedings of NLPXML2-2006 (Multi-dimensional Markup in Natural Language Processing), pages 19-26. Trento, Italy, 2006), with the output of each stage encoded in XML mark-up. An initial step of tokenisation and sentence-splitting is followed by part-of-speech tagging using the C&C part-of-speech tagger (Curran, J. R. and Clark, S., Investigating GIS and smoothing for maximum entropy taggers, in Proceedings of the 11th Meeting of the European Chapter of the Association for Computational Linguistics (EACL-03), pages 91-98, Budapest, Hungary, 2003), trained on the MedPost data (Smith, L., Rindflesch, T. and Wilbur, W. J., MedPost: a part-of-speech tagger for biomedical text. Bioinformatics, 20(14):2320-2321, 2004).

A lemmatiser module obtains information about the stems of inflected nouns and verbs using the Morpha lemmatiser (Minnen, G., Carroll, J. and Pearce, D., Robust, applied morphological generation, in Processing of 1st International Natural Language Generation Conference (NLG '2000), 2000). Information about abbreviations and their long forms (e.g. B cell linker protein (BLNK)) is computed in a step which calls Schwartz and Hearst's ExtractAbbrev program (Schwartz, A. S. and Hearst, M. A. Identifying abbreviation definitions in biomedical text, in Pacific Symposium on Biocomputing, pages 451-462, 2003). A lookup step uses ontology information to identify scientific and common English names of species for use downstream in the Term Identification component. A final step uses the LT-TTT2 rule-based chunker to mark up noun and verb groups and their heads (Grover, C. and Tobin, R., Rule-Based Chunking and Reusability, in Proceedings of the Fifth International Conference on Language Resources and Evaluation (LREC, 2006), Genoa, Italy, 2006.)

A named entity recognition module is used to recognise proteins, although one skilled in the art will recognise that other entities such as protein complexes, fragments, mutants and fusions, genes, methods, drug treatments, cell-lines etc. may also be recognized by analogous methods. The named entity recognition module was a modified version of a Maximum Entropy Markov Model (MEMM) tagger developed by Curran and Clark (Curran, J. R. and Clark, S., Language independent NER using a maximum entropy tagger, in Walter Daelemans and Miles Osborne, editors, Proceedings of CoNLL-2003, pages 164-167, Edmonton Canada, 2003, hereafter referred to as the C&C tagger) for the CoNLL-2003 shared task (Tiong Kim Sang, E. F. and De Mulder, F., Introduction to the CoNLL-2003 shared task: Language-independent named entity recognition, in Walter Daelemans and Miles Osborne, editors, Proceedings of CoNLL-2003, pages 142-147, Edmonton, Canada, 2003).

The vanilla C&C tagger is optimised for performance on newswire named entity recognition tasks such as CoNLL-2003, and so a tagger which has been modified to improve its performance on the protein recognition task is used. Extra features specially designed for biomedical text are included, a gazetteer containing possible protein names is incorporated, an abbreviation retagger ensures consistency with abbreviations, and the parameters of the statistical model have been optimised. The addition features which have been added using the C&C experimental feature option are as follows: CHARACTER: A collection of regular expressions matching typical protein names; WORDSHAPE: An extended version of the C&C ‘wordtype’ orthographic feature; HEADWORD: The head word of the current noun phrase; ABBREVIATION: Matches any term which is identified as an abbreviation of a gazetteer term in this document; TITLE: Any term which is seen in a noun phrase in the document title; WORDCOUNTER: Matches any non-stop word which is among the ten most commonly occurring in the document; NOLAST: The last (memory) feature of the C&C tagger was removed. The modified C&C tagger has also been extended using a gazetteer in the form of a list of proteins derived from RefSeq (http://www.ncbi.nlm.nih.gov/RefSeq/), which was pre-processed to remove common English words and tokenised to match the tokenisation imposed by the pipeline. The gazetteer is used to tag the proteins in the document and then to add the bio tag corresponding to this tagging and the bigram of the previous and current such bio tags as C&C experimental features to each word. The “tag prior” parameter in C&C has been varied in order to adjust the prior beliefs in the likelihood of each of the bio tags and thus optimise the decision boundary and improve the overall f1 score. The abbreviation retagger is implemented as a post-processing step, in which the output of the C&C tagger was retagged to ensure that it was consistent with the abbreviations predicted by the Schwarz and Hearst abbreviation identifier. If the antecedent of an abbreviation is tagged as a protein, then all subsequent occurrences of the abbreviation in the same document are tagged as proteins by the retagger.

A species tagger which has been trained on manually species-tagged annotated data is used in order to provide a term identification module which is able to disambiguate between species. The term identification module applies the following three steps to every protein mention until all protein mentions in a document are assigned an entity identifier. Firstly, candidate identifiers are assigned to each protein mention by performing an approximate search in an ontology which comprises synonyms of proteins and which has previously been expanded by inserting orthographic variants of the protein entries into the ontology, where the orthographic variants include the strings obtained by removing/adding spaces or hyphens between strings (e.g. “TEG 27” [symbol] “TEG27”), replacing the space between strings with a hyphen (e.g. “TEG 27” [symbol] “TEG-27”), etc. The approximate search generates variants of protein mentions according to rules, such as lowercasing the protein mention, substituting the term with abbreviation/long form partners, removing the protein mention's species indicating prefix (e.g. “hTAK1” [symbol] “TAK1”) and searching for the variant strings in the ontology. If a single candidate identifier is returned, the protein mention is monosemous and is assigned the single candidate identifier.

Otherwise, in a second step, the most likely species of the individual protein mention is identified using a species tagger trained on manually annotated data. The species tagger is a weka implementation of the Support Vector Machines algorithm (www.cs.waikato.ac.nz/˜ml/weka, Witten, I. H. and Frank, E. (2005), Data Mining: Practical machine learning tools and techniques, second edition, Morgan Kaufmann, San Francisco, 2005). Each training instance has been represented as a features-value pair, where features were TF-IDF weighted word lemmas that co-occur with the protein mention in a context window of size 50, and a value is the species which has been assigned to the protein mention by a human annotator. Candidate identifiers of proteins which do not match the species assigned to the protein mention are discarded. If only a single candidate identifier is left, it is assigned to the protein mention.

Otherwise, in a third step, a heuristic rule is applied to rank the remaining candidate identifiers and the top-ranked identifier is assigned to the individual protein mention. The heuristic rule favours identifiers which have the lowest numerical value. We have found that this improves term identification when the identifier is the accession number of a protein in the Cognia Molecular database and would anticipate the corresponding result if the identification was the accession number of the protein in RefSeq, as Cognia Molecular was initially derived from an earlier version of RefSeq.

After term identification, a relation extraction module uses simple contextual features to detect binary relations between proteins (Protein-Protein Interactions) in the digital representations of documents. For every pairing of proteins within a sentence, a relation candidate is created and its relevant features extracted. Probabilities are assigned to each instance using a Maximum Entropy Classifier (available from homepages.inted.ac.uk/s0450736/maxent_toolkit.html), and those instances with probabilities which exceeded a threshold are accepted as relations. The features used are: the combination of the indeces of the protein mentions of the interaction “P1-position:P2-position”; the combination of the lexical forms of the protein mentions of the interaction “P1:P2”; the lexical form, stemming/lemmatisation, part-of-speech tag and chunking information in a three-word context around the protein mentions; the distance, in tokens, between the two protein mentions; the number of other identified protein mentions between the two protein mentions; whether there is a coordination of negation structure between protein mentions; whether the document is an abstract or full paper; normalised forms of the protein mentions; concatenation of the words between proteins, and another features using the part-of-speech tags in the same manner; words between and right before/after proteins in a bag-of-words approach; bigrams and trigrams around protein mentions. The relation extraction module also uses the following information: a protein/gene interaction corpus derived from the BioCreAtivE task 1A data, as additional training data (described in Plake, C., Hakenberg, J. and Leser, U., Optimizing syntax-patterns for discovering protein-protein-interactions, in Proc ACM Symposium on Applied Computing, SAC, Bioinformatics Track, volume 1, pages 195-201, Santa Fe, USA, March 2005); a list of “interaction words” which have been determined to be information of when a protein-protein interactions occurs, such as interact, bind, inhibit, phosphorylation, were used for some features; the twenty-two syntactic patterns used in Plake et al., are each used as boolean features in regular expression form: “P1 word {0,n} Iverb word {0,m} P2”. All of the following features are extracted for the nearest interaction words found before, between and after each pair of protein mentions: whether an interaction word exists within a window of fifteen tokens; the distance between the interaction word and the protein it is closest to; the lexical form and part-of-speech tag of the interaction word; whether the interaction word is a Head Verb or Noun; and how many interactions words there are in the sentence.

### Example Document

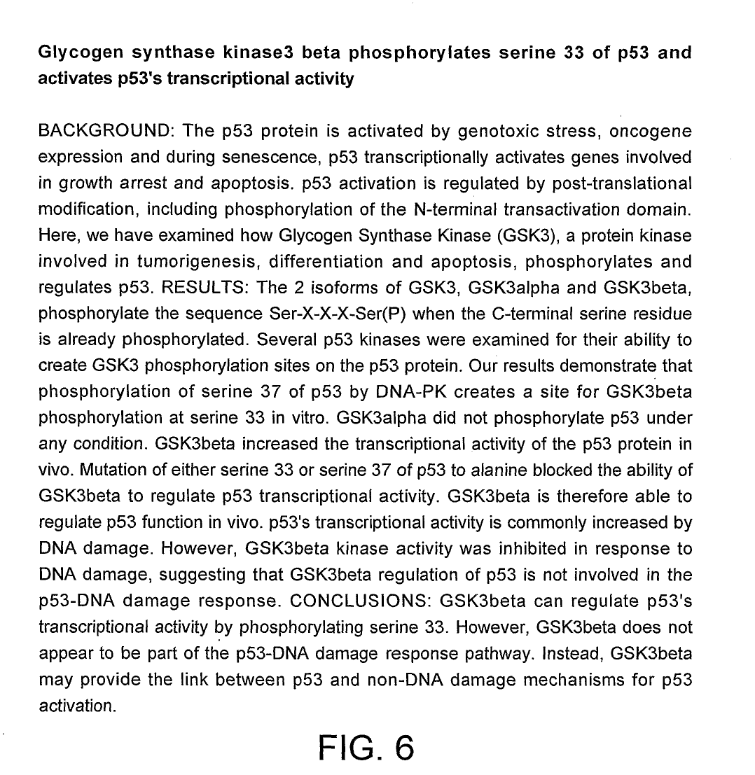

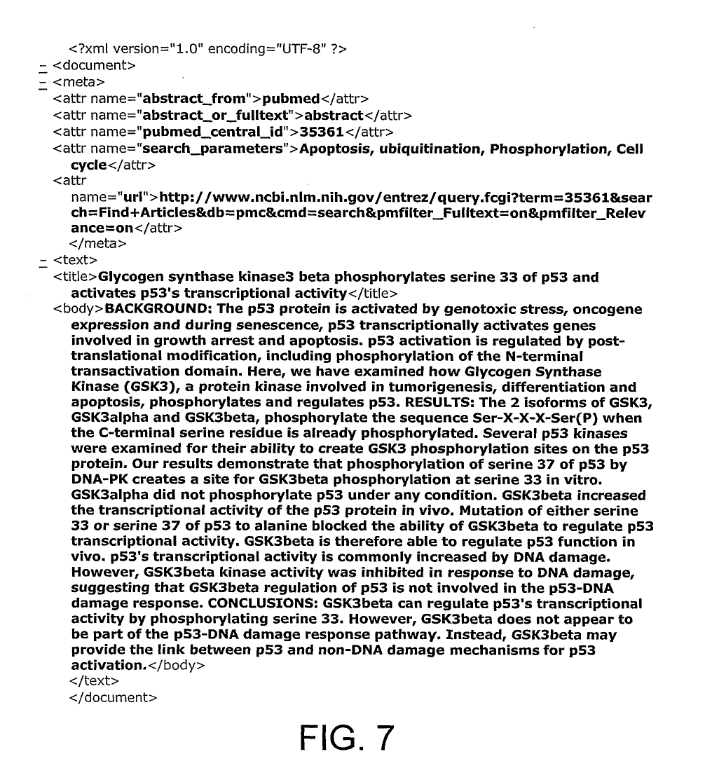

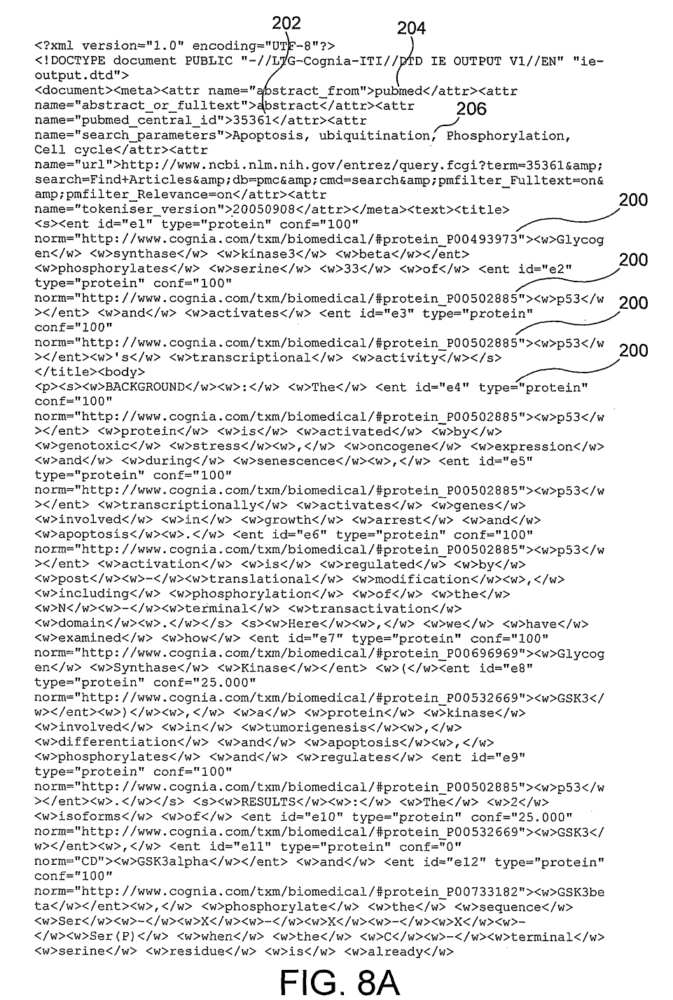

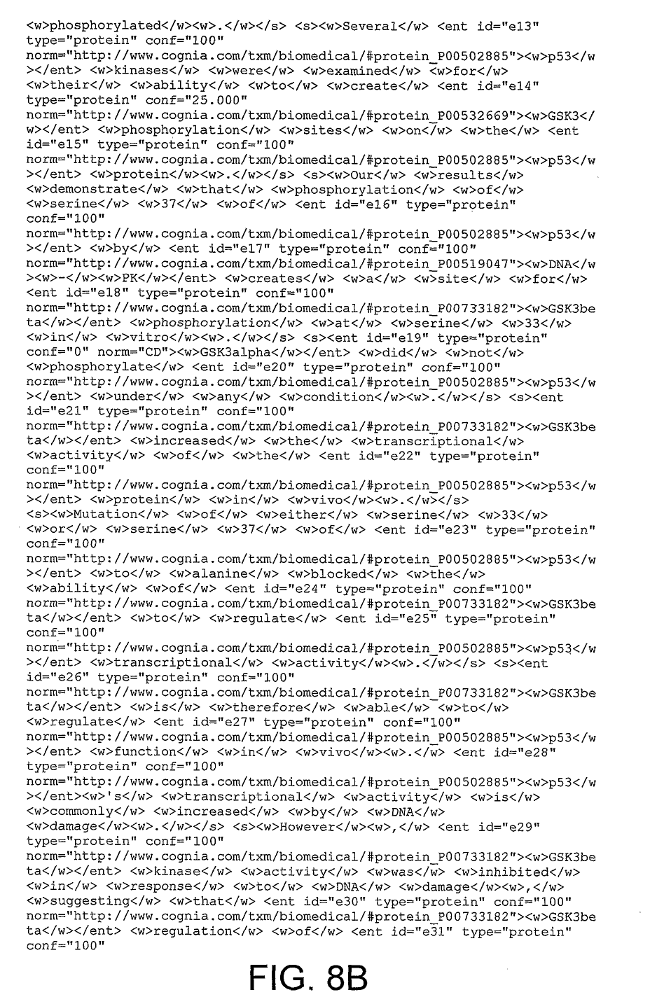

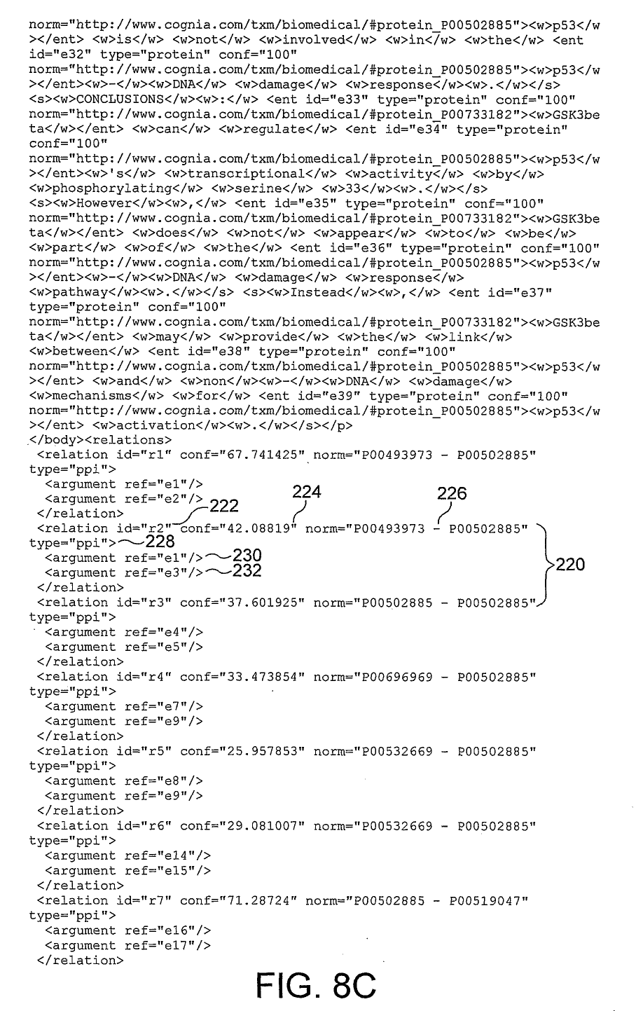

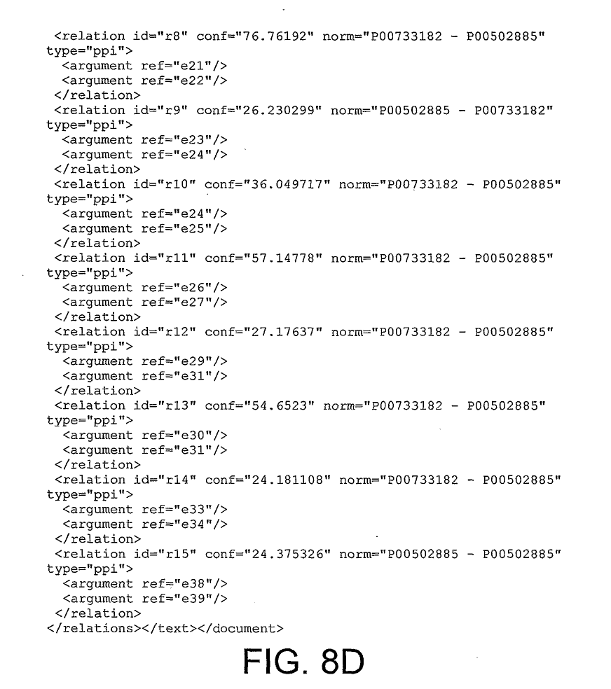

FIG. 6 is an example of a document suitable for processing by the system. FIG. 7 is an XML file of the same document included within the title and body tags of an XML file suitable for processing by the system. The body of the text is provided in plain text format within body tags. FIGS. 8A, 8B, 8C and 8D are successive portions of an annotated XML file concerning the example document after information extraction by the procedure described above.

The annotated XML file includes tags concerning instances of entities 200 (constituting annotation entity data). Each tag specifies a reference number for the instance of an entity (e.g. ent id=“e4”), the type of the entity (e.g. type=“protein”), the confidence of the term normalisation as a percentage (e.g. conf=“100”) and a reference to ontology data concerning that entity, in the form of a URI (e.g. norm=http://www.cognia.com/txm/biomedical/#protein_P00502885). (The reference to ontology data concerning that entity constitutes an identifier of an instance of an entity which is a reference to ontology data). Tags concerning each instance of an entity are included inline within the XML file just before the word (with a <w> prefix and </w> suffix) to which the data relates (thereby constituting data which specifies the location of the identified instance of the entity within the digital representation of the document).

The annotated XML file also includes a document identifier 202, as well as data specifying the source of the document which the document file represents 204 and information concerning the parameters of the search carried out to retrieve the original document file 206.

Relations which have been identified in the text are recorded as standoff annotation at the end of the annotated XML file (FIGS. 8C and 8D). Annotation data concerning an instance of a relation 220 (constituting annotation relation data) includes a reference number 222 for that instance of a relation, the confidence 224 of the relation extraction as a percentage, normalised form of the entities which the relation concerns 226, the type of the entity 228 (e.g. type=“ppi” denotes a protein-protein interaction), and the reference numbers 230, 232 of the entities which the relation concerns.

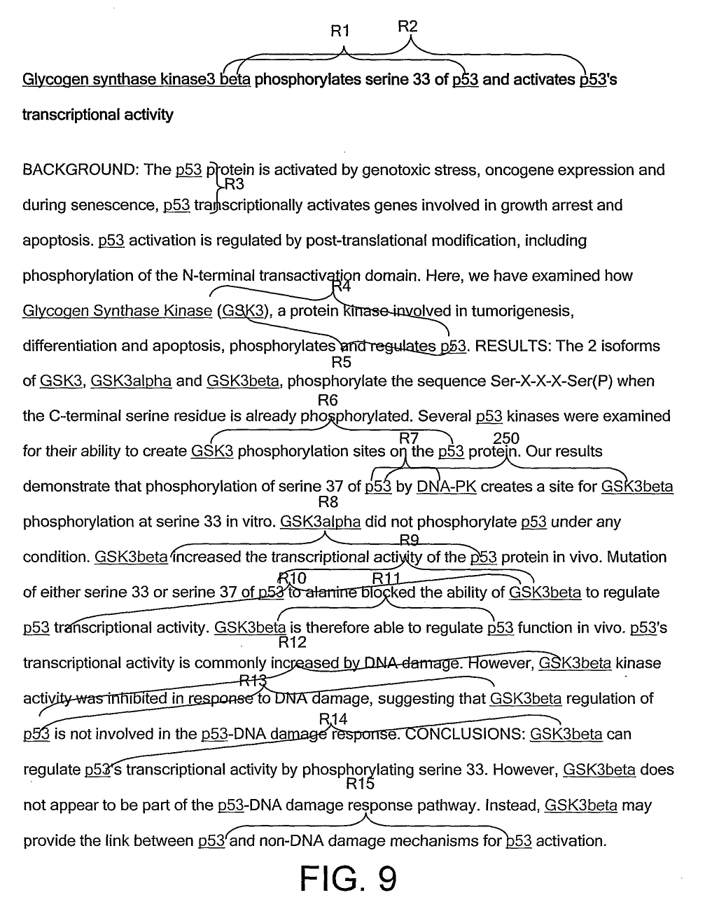

FIG. 9 is the document of FIG. 6 with the entities annotated in the XML file of FIGS. 8A to 8D underlined and the relations annotated in the XML file of FIGS. 8A to 8D indicated. Note that although the information extraction procedure has produced generally reliable results, there are errors. In particular, relation R6 is wrong and a further relation 250 has not been identified.

Following information extraction, the annotated XML file is stored in the relational database management system. At a later stage, the annotated XML file is curated via a curation tool user interface, allowing a human curator to add, delete and amend annotation data. For example, in the case of the annotated document shown in FIG. 9, a human curator may delete or correct relation R6 and manually add further relation 250. As well as allowing a human curator to add, delete and amend curation data, the curation tool user interface also allows the human curator to select data for output to a target database.

### Curation

The curation tool user interface is implemented by the web service component delivering a Java application to a computer which executes the application, as well as the annotated XML file relating to the document to be curated. A user interacts with the interface via the computer's monitor and input peripherals such as a keyboard and computer mouse.

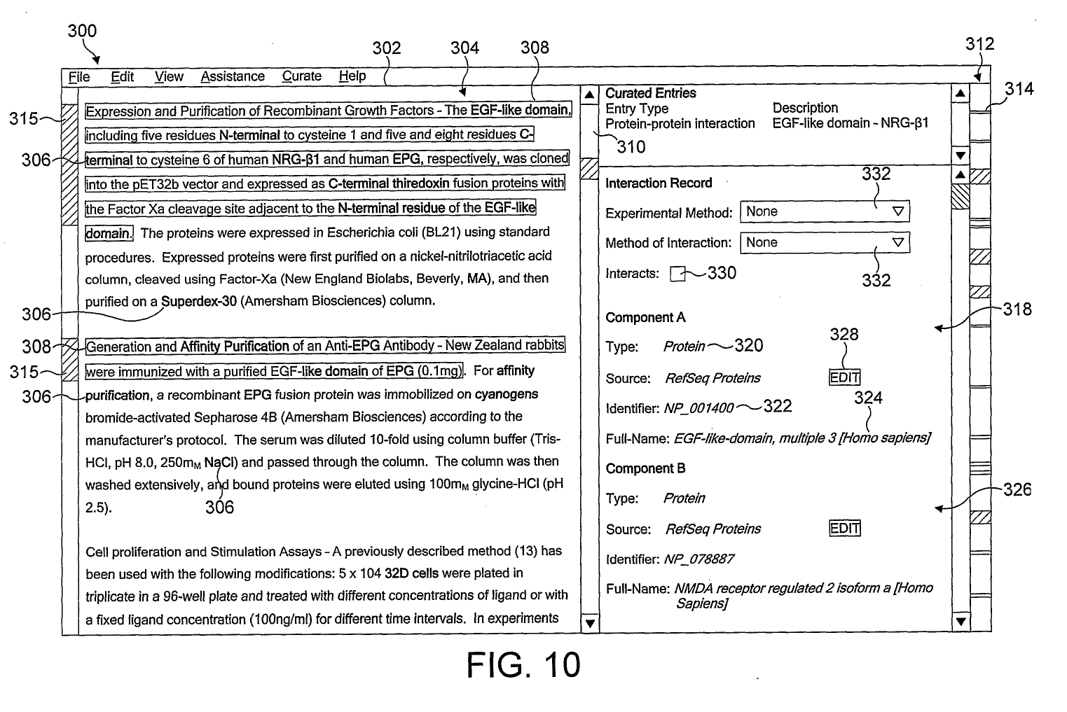

FIG. 10 is a screenshot of a curation user interface 300. The user interface displays a document display window 302 showing a document 304. Individual instances of entities 306 are highlighted at the location in the document which is specified by the annotation data (i.e. by the location of the tag concerning that instance of an entity within the XML file). In this example, each instance of an entity is highlighted by rendering it in bold. Not all instances of entities have been labelled, for clarity. Entities may be highlighted only in response to a request by a user (e.g. by selecting a menu option), or may be highlighted at all times. Accordingly, a part of the document which is visible within the document display window includes annotations (bold text) to highlight entities which were identified by the natural language processing pipeline. Within the document display window, relations 308 are annotated by highlighting them with a box around the text which describes the relation. The box may, for example, be in colour. The document display window further comprises a standard window scroll bar 310 enabling a user to scroll through the document.

The curation user interface further includes a navigation tool in the form of a first elongate bar 312 which indicates features of the document which have been automatically identified by representing them with a colour bar 314 or other visual indicator at a position in the elongate bar which is proportional to their location within the document. Different types of features, such as protein mentions or other named entities, identified relations, or automatically identified section headings (such as “Introduction”, “Materials and Methods” etc.) are displayed using different coloured bars or visual indicators. A second elongate bar 314 is an expanded representation of the features indicated in the first elongate bar which are visible in the section of the document which is currently displayed in the document display window. For example, a coloured bar 315 is provided alongside each identified relation. The second elongate bar is dynamically updated when the section of the document which is displayed is changed using the scrolls bar or other user interface feature. The annotations representing entities and relations at their identified location within the document facilitate easy identification of relevant sections of the document, which require detailed study, by the curator.

The user-interface also provides means for a user to select a relation which has been automatically identified using a pointing device, such as a mouse, or another user interface feature responsive to which provisional amended annotation data is prepared from the automatically identified annotation data concerning the selected relation. The provisional amended annotation data is then represented in an annotation amendment window 316. The annotation amendment window comprises a first section 318 which represents data concerning the entity which is the first component of a relation, including details of the type of entity 320 (e.g. protein), and the identifier 322 of the entity which was automatically identified during the natural language information extraction procedure. A canonical form of the name of the entity 324, obtained from the ontology, is also displayed. Corresponding information is provided in a second section 326 of the annotation amendment window in connection with the second entity which the relation concerns.

A curator may accept the provisional amended annotation data as correctly representing the relation and indicate using a user-interface feature (such as a button or menu choice) that the provisional amended annotation data is correct and should be used to create output data for export to a target database. However, the curator may also amend the provisional amended annotation data, for example they may select a user-interface feature such as a button 328 which enables them to edit the data concerning one or both of the identified entities using common user-interface features such as check boxes 330, text boxes, drop-down menus 332, lists etc. Thus, the curator may correct erroneous annotation data, for example an incorrect identification of an entity, or add annotation data which was omitted by the information extraction procedure (for example, an omitted entity). Added annotation data may include data which the information extraction procedure is not capable of extracting. For example, where the information extraction procedure is capable of identifying an entity, but not capable of identifying a property of the entity, this data can be input by a user, thereby obtaining an efficiency benefit from the user of an information extraction procedure, without the disadvantage of being able only to output data derived from the information extraction procedure. A curator may also create an entirely new provisional amended annotation data record. For example, they may create provisional amended annotation data concerning a relation which was not identified by the information extraction procedure, and then edit the provisional amended annotation data.

Examples of annotation data concerning entities which may be viewed and/or edited include the type of entity, the identifier of the entity, the canonical form of the entity, properties of the entity (e.g. whether and how it is modified). Examples of relation data concerning relations which may be viewed and/or edited include the identifiers of the entities which the relation concerns, a description of the relation and properties of the relation, e.g. the experimental method which lead to the relation (e.g. affinity purification), the method of interaction (e.g. phosphorylation) and whether the relation concerns an interaction.

Once the provisional annotation data concerning an entity (provisional annotation entity data) or a relation (provisional annotation relation data) has been edited, the resulting data is considered to be curated (i.e. approved by a curator) and stored for export to a target database, in whole or in part, as output data. Essentially, one or more records which constitute provisional annotation data have been pre-populated using annotation data which was prepared by the information extraction procedure, and then edited before being selected for export to a target database.

An example of the annotation relation data which could be stored for export is as follows:

“Between character offset 100 and character offset 200 of Document ID 123 which is from the “Medline Abstract” collection and has PubMed ID 456, ‘p19’ (protein p19, ontology ID 135) and ‘ADP ribosylation factor’ (protein Arf, ontology ID 680) are said to interact.”

Thus, the annotation relation data may include a reference to the start and end locations of a fragment of text which refers to a particular relation (‘character offset 100’ and ‘character offset 200’), as well as document identifiers (including internal document identifier, ‘Document ID 123’, and corresponding external document identifier, ‘PubMed ID 456’) and an identifier of the source (“Medline Abstract” collection) of the documents, as well as both the text denoting the related entities both as it is found in the document (‘p19’, ‘ADP ribosylation factor) and in its normalised form (‘p19’ and ‘Arf’). The annotation relation data can also include the type of the entities (‘protein’) and their IDs within ontology data (‘ontology ID 680’ and ‘ontology ID 135’) as well as details of the nature of the relation (‘are said to interact’).

One skilled in the art will recognise that the above annotation relation data could be stored in many different ways. Some or all of the annotation relation data may be exported to the target database.

In the above example, the annotation data in the input XML file is not amended. In an alternative embodiment, rather than editing provisional annotation data to form amended annotation data which is separate to the XML file concerning the edited document, the annotation data in the XML file, which was originally generated by the information extraction procedure, is amended. For example, where the document is received in the form of an XML file including annotation data, the curating procedure may finish by outputting an XML file including amended annotation data. In some circumstances, this would not be desirable because additional processing would be required to edit an XML file to reflected changes in annotation data in comparison to simply outputting curated provisional annotation data without the additional computing step of amending the annotation data included in an XML file. However, it may be advantageous to amend the underlying annotation data in certain circumstances, particularly when using the system to prepare training data for use in training a machine learning-based information extraction module.

Optionally, a local copy in system memory of annotation data in or relating to the input XML file may be amended during the editing procedure and used to dynamically update the display of the document with annotations.

### Export

Periodically, the target service exports curated data to the target database. The target service proceeds systematically through the data to be exported in turn, checking whether the data is already found within the target database. If it is not, then the data is inserted into the target database by calling the API of the target database or generating an SQL insert/update. It may be necessary to translate the data into an appropriate format for the target database. If the target database has different ontology data, it is necessary to translate these references. The procedure can be repeated or carried out concurrently to populate more than one target database.

### Feedback

A potentially important optional feature of the invention is the provision of feedback in which data produced by the curation process is used in the automatic analysis of future document files.

### Feedback—Ontology Data

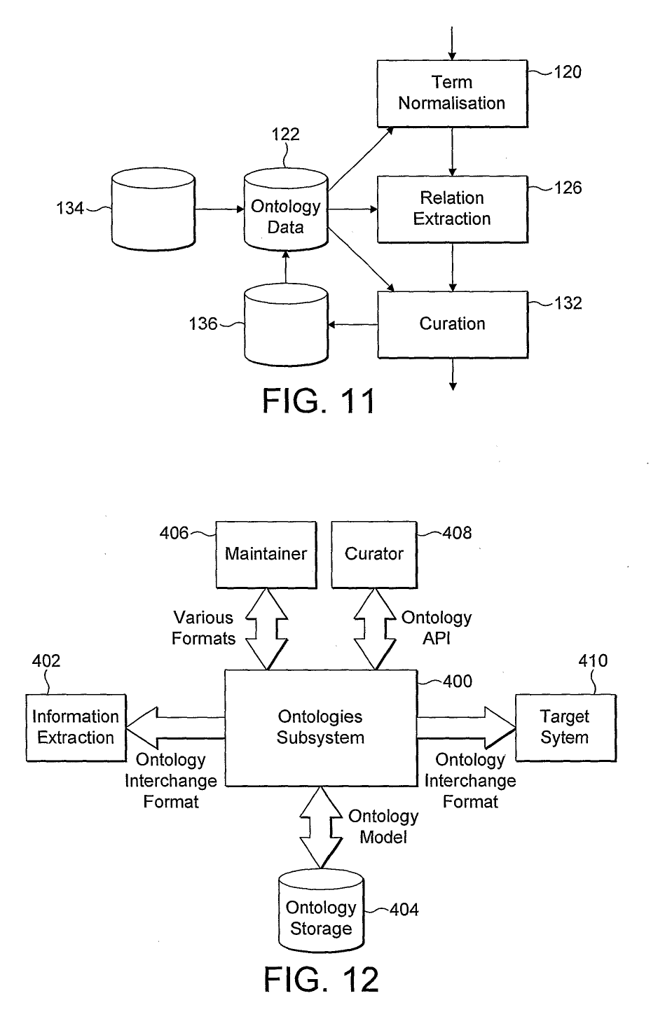

FIG. 11 is a schematic diagram of the feedback of ontology data for use in information extraction. Ontology data 122 concerning entities is used during the step of term normalization and ontology data concerning relations may also be used during the step of relation extraction. The ontology data used during these steps is a combination of predetermined ontology data 134 and new ontology data 136 added by curators during the curation process. This feedback procedure improves the reliability of the information extraction procedure, improving the cost-effectiveness and in some circumstances accuracy of the system as a whole. New ontology data can be added batchwise to the ontology data used for information extraction from time to time, or may be added immediately to the ontology data used for information extraction.

A more sophisticated ontology maintenance system is illustrated in FIG. 12. Ontology subsystem 400 provides ontology data concerning entities, and optionally relations, to information extraction module 402 (comprising tokenisation, named entity recognition, term normalisation and relation extraction modules). Ontology data is stored in ontology storage system 404 and the information extraction module is adapted to allow the ontology data to be amended by a maintainer 406 and by one or more curators 408. Furthermore, the information extraction module receives ontology data from target database 410, translating the format of the ontology data if required. This allows the ontology data to be updated as the target database is updated. A look-up table may be stored to allow references to entities (and optionally relations) in the information extraction and curation system to be mapped to entities (and optionally relations) in the target database.

In one example embodiment, the ontology data simply comprises a lexicon of entity names (for example, protein names). Each entity within the lexicon has a unique ontology identifier, a string denoting its normalised form, and strings denoting synonyms of the entity. A lexicon of this type can readily be prepared by extracting the relevant information from a more complex ontology.

### Feedback—Training Data

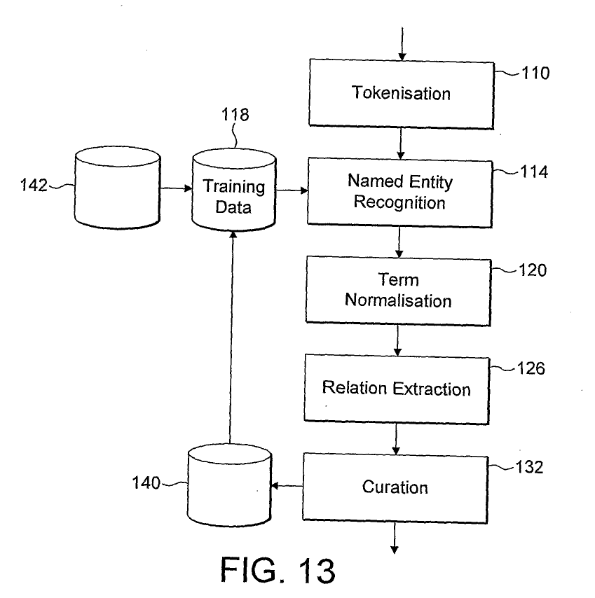

FIG. 13 is a schematic diagram of the feedback of training data within the system. The named entity recognition module is initially trained using training data which has been provided for the purpose and which typically consists of annotated document files which have been carefully checked to ensure that they are correctly annotated.

Whilst carrying out the curation process, the curator can select a document which they have been curating, or a part thereof, whereupon the annotated document file (or part thereof) resulting from their curation is stored in a database 140 of selected annotated document files. Periodically, the named entity recognition software module is retrained using training data 118 comprising both data from the database of selected annotated document files and also a database of predetermined annotated document files 142. In this case, the curation tool will typically enable a user to amend annotation data and to include the amended annotation data in an output XML file rather than to simply output data derived from the annotation data without amending the underlying annotation data included in the XML file.

One skilled in the art will recognise that other modules within the information extraction system could be retrained using training data selected in this way. An important benefit of selecting training data in this way is that the curators will be able to recognise when automatic analysis of a particular document file has been carried out badly by the information extraction system and so select document files of particular relevance for use in retraining.

Documents which are cited above are incorporated herein by virtue of this reference.

Further modifications and variations may be made within the scope of the invention herein disclosed.

1. A method of editing annotation data associated with a digital representation of a document, the method comprising the steps carried out by computing apparatus of:
(i) receiving as input data a digital representation of a document and annotation data, the annotation data comprising annotation entity data concerning one or more instances of entities which have been identified in the digital representation of a document, the annotation entity data comprising identifiers of instances of one or more entities which have been identified in the digital representation of a document and data specifying the location of the identified instances of entities within the digital representation of a document, wherein the identifiers of instances of entities comprise references to ontology data;
(ii) displaying at least part of the digital representation of a document to a user of computer-user interface means, with annotations dependent on the annotation data, the said annotations including at least highlighting one or more of the instances of entities whose location is specified in the annotation entity data at the location within the digital representation of a document specified by the annotation entity data;
(iii) preparing amended annotation data responsive to instructions received from a user of the computer-user interface means; and
(iv) outputting output data derived from the amended annotation data.

2. A method of populating a database comprising the steps of editing annotation data associated with a digital representation of a document by a method as claimed in claim 1, and populating the database with the output data.

3. A method of populating a database as claimed in claim 2, wherein the annotation data which is received as input data for the step of editing annotation data is obtained by the steps carried out by computing apparatus of receiving as input data a digital representation of a document, analysing the digital representation of a document, identifying one or more instances of entities contained in the digital representation of the document and, for at least some of the identified instances of entities, storing annotation data comprising annotation entity data concerning one or more instances of entities which have been identified in the digital representation of a document, the annotation entity data comprising identifiers of instances of one or more entities which have been identified in the digital representation of a document and data specifying the location of the identified instances of entities within the digital representation of a document, wherein the identifiers of entities comprise references to ontology data and wherein the stored annotation data is used as the input data for the step of editing annotation data.

4. A method as claimed in claim 3, wherein the analysis of the digital representation of a document is carried out by a trainable information extraction module which is trainable using training data which comprises digital representations of documents and annotation data comprising the location of instances of entities and/or relations in the documents and identifiers of the identified entities and/or relations, and the computer-user interface means is adapted to allow an analysed digital representation of a document and annotation data relating to entities and/or relations referred to in the digital representation of the document to be selected by a user for use as training data for training the trainable information extraction module, and the method further includes the step of retraining the trainable information extraction module using data comprising the selected training data and using the retained trainable information extraction module in the analysis of further documents.

5. A method as claimed in claim 4, wherein the trainable information extraction module comprises a trainable named entity recognition module.

6. A method as claimed in claim 1, which is repeated to allow the analysis and review of digital representations of a plurality of documents.

7. A method as claimed in claim 1, wherein the step of preparing amended annotation data comprises amending the annotation data and interactively updating the display provided by the computer-user interface means.

8. A method as claimed in claim 1, wherein preparing amended annotation data comprises displaying provisional amended annotation data derived from the annotation data and updating the provisional amended annotation data responsive to instructions received from a user of the computer-user interface means.

9. A method as claimed in claim 8, wherein the computer-user interface means is adapted to create and display provisional amended annotation data derived from annotation data responsive to selection by a user of the displayed annotation which is dependent on the said annotation data.

10. A method as claimed in claim 1, wherein the output data does not comprise the location of the identified instances of entities within the digital representation of a document.

11. A method as claimed in claim 1, wherein the output data comprises a document identifier.

12. A method as claimed in claim 1, comprising the step of retrieving digital representations of documents fulfilling one or more criteria, and the step of storing some or all of the said criteria in the annotation data.

13. A method as claimed in claim 1, wherein the annotation data comprises annotation relation data concerning instances of relations between entities described by the digital representation of the document and the step of amending the annotation data comprises the step of receiving data concerning one or more instances of relations between entities from a user of the computer-user interface means and amending the annotation relation data accordingly.

14. A method as claimed in claim 13, wherein the output data comprises output relation data concerning one or more relations between entities, which relations are described by the document, the said data concerning one or more relations being derived from the amended annotation data.

15. A method as claimed in claim 13, wherein the output relation data comprises properties of relations derived automatically from the digital representation of a document and the step of analysing the digital representation of a document includes the step carried out by computing apparatus of determining properties of relations.

16. A method as claimed in claim 14, wherein the annotation relation data concerns specific instances of a relation within the digital representation of a document, but the output relation data concerns the relation per se.

17. A method as claimed in claim 13, wherein the amendments to the annotation data responsive to instructions from a user of the computer-user interface means comprise one or more of: deleting annotation entity data concerning an instance of an entity; amending annotation entity data concerning an instance of an entity; adding annotation entity data concerning an instance of an entity; deleting annotation relation data concerning an instance of a relation; amending annotation relation data concerning an instance of a relation; and adding annotation relation data concerning an instance of a relation.

18. A method as claimed in claim 1, wherein the annotation entity data concerns specific instances of an entity within the digital representation of a document, but the output data concerns the entity per se.

19. A method as claimed in claim 1, wherein the entity identifier is a reference to data, within ontology data, which concerns a particular entity, and the ontology data comprises synonyms of entities and normalised forms of entities.

20. A method as claimed in claim 1, wherein some or all of the annotation entity data is embedded inline within the digital representation of the document and it is the location of the entity data within the digital representation of the document which specifies the location of the entity within the digital representation of the document.

21. A method as claimed in claim 20, wherein the digital representation of the document comprises an XML file and the annotation data comprises tagged values within the XML file.

22. A method as claimed in claim 1, wherein the digital representation of a document comprises data representing text.

23. A method as claimed in claim 1, wherein the document is in an electronic format and the electronic representation of a document is the document or a copy thereof.

24. A method as claimed in claim 1, wherein the digital representation of the document is a representation of only part of the document.

25. A method as claimed in claim 1, wherein the document identifier identifies the document.

26. A method as claimed in claim 1, wherein the database comprises some or all of: data concerning entities, data concerning properties of entities, data concerning relations between entities and data concerning properties of relations between entities.

27. A method as claimed in claim 1, wherein one or more of the instances of entities are highlighted at the location within the digital representation of a document which is specified by annotation entity data by presenting the instance of the entity differently to surrounding text.

28. A method as claimed in claim 1, wherein the annotation data comprises annotation relation data concerning one or more instances of relations and the one or more instances of relations are highlighted at the location within the digital representation of a document which is specified by the annotation relation data by displaying the instance of the relation differently to surrounding text.

29. A method as claim in claim 1, wherein the annotation data comprises annotation relation data concerning one or more instances of relations and wherein one or more instances of relations are displayed to a user of computer-user interface means other than at a location within the digital representation of the document which describes that relation.

30. A method as claimed in claim 1, wherein the computer-user interface means comprises means for enabling a user to select one or more instances of entities and to selectively display at least part of the digital representation of a document with the said selected instances of entities being highlighted differently to other instances of entities or the only highlighted instance of an entity.

31. A method as claimed in claim 1, wherein the annotation data comprises annotation relation data concerning one or more instances of relations and wherein the computer-user interface means comprises means for enabling a user to select one or more instances of relations and to selectively display at least part of the digital representation of a document with the said selected instances of relations being highlighted differently to other instances of relations or the only highlighted instance of a relation.

32. A method as claimed in claim 1, wherein the annotation data comprises annotation relation data concerning one or more instances of relations and the computer-user interface means is adapted to allow a user to select whether the database is to be populated with output data concerning a particular relation, and the step of populating the database with output data include the step of populating the database with data concerning only one or more relations which were selected.

33. A method as claimed in claim 1, wherein the computer-user interface means is adapted to enable a user to amend the ontology data and the method comprises the step of amending the ontology data responsive to instructions received through a user of the computer-user interface means.

34. A method as claimed in claim 33, wherein the method further comprises the step of using the ontology data which has been amended, or amendable, responsive to instructions received by the user of computer-user interface means for the analysis of further digital representations of documents.

35. A method as claimed in claim 1, wherein the computer-user interface means is adapted to allow a user to select a batch of digital representations of documents for analysis and then to sequentially and/or simultaneously display the batch of digital representations of documents and amend annotation data concerning the batch of digital representations of documents.

36. A method of populating a second database, the method comprising the steps of populating a first database by the method of claim 1, and exporting some or all of the data used to populate the first database from the first database to the second database.

37. A method according to claim 36, wherein the identifiers of entities in the first database refer to first ontology data and the identifiers of entities in the second database refer to second ontology data and the step of exporting some or all of the said data comprises the step of translating references to the first ontology data to references to the second ontology data.

38. A method according to claim 37, further comprising the step of importing ontology data from the second ontology data into the first ontology data, converting the format of the ontology data if required, and using the imported ontology data during the analysis of further documents.

39. A method according to claim 35, comprising the step of populating a plurality of second databases, at least two of which comprise different ontology data and/or different identifiers of entities.

40. A method of creating a further database comprising the steps of populating a database by the method of claim 1 and then including within the further database some or all of the output data with which a database was populated, translating or converting that data into another format if need be.

41. A database populated by the method of claim 1.

42. A method of outputting data responsive to a search request, comprising the steps of populating a database using the method of claim 1, receiving a search request, querying the database to retrieve data relevant to the search request and outputting the retrieved data.

43. A method as claimed in claim 42, comprising the step of retrieving one or more digital representations of a document responsive to a search request, subsequently populating the database using the steps carried out by computing apparatus of:
(i) receiving as input data a digital representation of a document and annotation data, the annotation data comprising annotation entity data concerning one or more instances of entities which have been identified in the digital representation of a document, the annotation entity data comprising identifiers of instances of one or more entities which have been identified in the digital representation of a document and data specifying the location of the identified instances of entities within the digital representation of a document, wherein the identifiers of instances of entities comprise references to ontology data;
(ii) displaying at least part of the digital representation of a document to a user of computer-user interface means, with annotations dependent on the annotation data, the said annotations including at least highlighting one or more of the instances of entities whose location is specified in the annotation entity data at the location within the digital representation of a document specified by the annotation entity data;
(iii) preparing amended annotation data responsive to instructions received from a user of the computer-user interface means; and
(iv) outputting output data derived from the amended annotation data; and
(v) subsequently outputting data comprising data concerning the said retrieved digital representations of documents.

44. A method as claimed in claim 32, further comprising the step of including the retrieved data, or data derived from the retrieved data, within a file and transmitting that file responsive to the search request.

45. A method of creating or amending an ontology database comprising ontology data, comprising the steps carried out by computing apparatus of:
(i) receiving as input data a digital representation of a document;
(ii) analysing the digital representation of a document, identifying one or more instances of entities contained in the digital representation of the document and, for at least some of the identified instances of entities, storing annotation data comprising annotation entity data concerning one or more instances of entities which have been identified in the digital representation of a document, the annotation entity data comprising identifiers of instances of one or more entities which have been identified in the digital representation of a document and data specifying the location of the identified instances of entities within the digital representation of a document, wherein the identifiers of entities comprise references to the ontology data;
(iii) displaying at least part of the digital representation of a document to a user of computer-user interface means, with annotations dependent on the annotation data, the said annotations including at least highlighting one or more of the instances of entities whose location is specified in the annotation entity data at the location within the digital representation of a document specified by the annotation entity data;
(iv) providing the user of computer-user interface means with means to amend the ontology data;
(iv) preparing amended annotation data responsive to instructions received from a user of the computer-user interface means; and (v) amending the ontology data responsive to instructions received by a user of the computer-user interface means.

46. A method as claimed in claim 45, wherein the step of amending the ontology data comprises one or more of deleting ontology data, adding ontology data or amending ontology data.

47. A method as claimed in claim 45 wherein the ontology data comprises a normalised form of an entity.

48. A method as claimed in claim 45, further comprising the step of creating an ontology database by including within that database some or all of the amended ontology data.

49. Ontology data obtained by the method of claim 45.

50. A method of training a trainable information extraction module, comprising the steps carried out by computing apparatus of:
(i) receiving as input data a digital representation of a document;
(ii) analysing the digital representation of a document using the trainable information extraction module, the trainable information extraction module identifying one or more instances of entities contained in the digital representation of the document and, for at least some of the identified instances of entities, storing annotation data comprising annotation entity data concerning one or more instances of entities which have been identified in the digital representation of a document, the annotation entity data comprising identifiers of instances of one or more entities which have been identified in the digital representation of a document and data specifying the location of the identified instances of entities within the digital representation of a document, wherein the identifiers of entities comprise references to ontology data;
(iii) displaying at least part of the digital representation of a document to a user of computer-user interface means, with annotations dependent on the annotation data, the said annotations including at least highlighting one or more of the instances of entities whose location is specified in the annotation entity data at the location within the digital representation of a document specified by the annotation entity data;
(iv) preparing amended annotation data responsive to instructions received from a user of the computer-user interface means;
(v) providing a user of the computer-user interface means with means to select a digital representation of a document for use in training the trainable information extraction module; and
(vi) periodically retraining the trainable information extraction module using training data comprising at least part of the selected digital representation of a document and the amended annotation data which concerns the selected digital representation of a document.

51. A method as claimed in claim 50, wherein the computer-user interface means is adapted to enable a user to select a portion of the digital representation of a document for use in retraining the information extraction module and that selected portion of the digital representation of a document is used for retraining the information extraction module.

52. A method as claimed in claim 50, wherein the trainable information extraction module comprises a tokenisation module, a named entity recognition module, a term normalisation module and a relation extraction module, and wherein the named entity recognition module is trainable.

53. A system for editing annotation data associated with a digital representation of a document, the system comprising computer-user interface means and output means;
wherein the computer-user interface means is operable to receive as input data a digital representation of a document and annotation data, the annotation data comprising annotation entity data concerning one or more instances of entities which have been identified in the digital representation of a document, the annotation entity data comprising identifiers of instances of one or more entities which have been identified in the digital representation of a document and data specifying the location of the identified instances of entities within the digital representation of a document, wherein the identifiers of instances of entities comprise references to ontology data;
and wherein the computer-user interface means is operable to display at least part of the digital representation of a document to a user of the computer-user interface means, with annotations dependent on the annotation data, the said annotations including at least highlighting one or more of the instances of entities whose location is specified in the annotation entity data at the location within the digital representation of a document specified by the annotation entity data;
and wherein the computer-user interface means is operable to receive instructions from a user of the computer-user interface means and to prepare amended annotation data responsive to the received instructions;
and wherein the output means is operable to output data derived from the amended annotation data.

54. A system for populating a database, the system comprising computer-user interface means and output means;
wherein the computer-user interface means is operable to receive as input data a digital representation of a document and annotation data, the annotation data comprising annotation entity data concerning one or more instances of entities which have been identified in the digital representation of a document, the annotation entity data comprising identifiers of instances of one or more entities which have been identified in the digital representation of a document and data specifying the location of the identified instances of entities within the digital representation of a document, wherein the identifiers of instances of entities comprise references to ontology data;
and wherein the computer-user interface means is operable to display at least part of the digital representation of a document to a user of the computer-user interface means, with annotations dependent on the annotation data, the said annotations including at least highlighting one or more of the instances of entities whose location is specified in the annotation entity data at the location within the digital representation of a document specified by the annotation entity data;
and wherein the computer-user interface means is operable to receive instructions from a user of the computer-user interface means and to prepare amended annotation data responsive to the received instructions;
and wherein the output means is operable to populate the database with output data derived from the amended annotation data.

55. A system for populating a database, the system comprising analysis means, computer-user interface means and output means;
wherein the analysis means is operable to receive as input data a digital representation of a document and to analyse the digital representation of a document, identify one or more instances of entities contained in the digital representation of the document and, for at least some of the identified instances of entities, store annotation data comprising annotation entity data concerning one or more instances of entities which have been identified in the digital representation of a document, the annotation entity data comprising identifiers of instances of one or more entities which have been identified in the digital representation of a document and data specifying the location of the identified instances of entities within the digital representation of a document, wherein the identifiers of entities comprise references to ontology data;
wherein the computer-user interface means is operable to receive as input data a digital representation of a document and the annotation data stored by the analysis means and to display at least part of the digital representation of a document to a user of the computer-user interface means, with annotations dependent on the annotation data, the said annotations including at least highlighting one or more of the instances of entities whose location is specified in the annotation entity data at the location within the digital representation of a document specified by the annotation entity data;
wherein the computer-user interface means is operable to receive instructions from a user of the computer-user interface means and to prepare amended annotation data responsive to the received instructions;
and wherein the output means is operable to populate the database with output data derived from the amended annotation data.

56. A system as claimed in claim 55, further comprising a trainable information extraction module which is trainable using training data which comprises digital representations of documents and annotation data comprising the location of instances of entities and/or relations in the documents and identifiers of the identified entities and/or relations, and the computer-user interface means is operable to allow an analysed digital representation of a document and annotation data relating to entities and/or relations referred to in the digital representation of the document to be selected by a user for use as training data for training the trainable information extraction module, and the system is configured to retrain the trainable information extraction module using data comprising the selected training data and to use the retained trainable information extraction module in the analysis of subsequent documents.

57. A system as claimed in claim 56, wherein the trainable information extraction module comprises a trainable named entity recognition module.

58. A system as claimed in claim 53, wherein some or all of the annotation entity data is embedded inline within the digital representation of the document and it is the location of the entity data within the digital representation of the document which specifies the location of the entity within the digital representation of the document.

59. A system as claimed in claim 58, wherein the digital representation of the document comprises an XML file and the annotation data comprises tags within the XML file.

60. A system as claimed in claim 53, wherein the computer-user interface means highlights one or more of the instances of entities at the location within the digital representation of a document which is specified by annotation entity data by presenting the instance of the entity differently to surrounding text.

61. A system as claimed in claim 53, wherein the annotation data comprises annotation relation data concerning one or more instances of relations and the computer-user interface is highlights one or more instances of relations at the location within the digital representation of a document which is specified by the annotation relation data by displaying the instance of the relation differently to surrounding text.

62. A system as claimed in claim 53, wherein the computer-user interface means comprises means for enabling a user to select one or more instances of entities and to selectively display at least part of the digital representation of a document with the said selected instances of entities being highlighted differently to other instances of entities or the only highlighted instance of an entity.

63. A system as claimed in claim 53, wherein the annotation data comprises annotation relation data concerning one or more instances of relations and wherein the computer-user interface means comprises means for enabling a user to select one or more instances of relations and to selectively display at least part of the digital representation of a document with the said selected instances of relations being highlighted differently to other instances of relations or the only highlighted instance of a relation.

64. A system as claimed in claim 53, wherein the annotation data comprises annotation relation data concerning one or more instances of relations and the computer-user interface means is adapted to allow a user to select whether the database is to be populated with output data concerning a particular relation, and output means is adapted to populate the database with data concerning only one or more relations which were selected.

65. A system as claimed in claim 53, wherein the computer-user interface means is adapted to enable a user to amend the ontology data responsive to instructions received through a user of the computer-user interface means.

66. A system as claimed in claim 65, adapted to use the ontology data which has been amended, or amendable, responsive to instructions received by the user of computer-user interface means for the analysis of further digital representations of documents.

67. A system as claimed in claim 53, wherein the computer-user interface means is adapted to allow a user to select a batch of digital representations of documents for analysis and then to sequentially and/or simultaneously display the batch of digital representations of documents and amend annotation data concerning the batch of digital representations of documents.

68. A system for populating a second database, comprising a system for populating a first database according to claim 54 and a first database, and a data export module operable to export some or all of the data used to populate the first database from the first database to the second database.

69. A system as claimed in claim 68, wherein the identifiers of entities in the first database refer to first ontology data and the identifiers of entities in the second database refer to second ontology data and the export module is adapted to translate references to the first ontology data to references to the second ontology data.

70. A system as claimed in claim 69, operable to import ontology data from the second ontology data into the first ontology data, convert the format of the ontology data if required, and to use the imported ontology data during the analysis of further documents.

71. A system as claimed in claim 68, operable to populate a plurality of second databases, at least two of which comprise different ontology data and/or different identifiers of entities.

72. A system for outputting data responsive to a search request, comprising a system for populating a database according to claim 54, a database populated by the system for populating a database, means to receive a search request, means to query the database to retrieve data relevant to the search request and means to output the retrieved data.

73. Program instructions for programming computer apparatus which, when executed on programmable computer apparatus, cause the programmable computer apparatus to carry out the method of claim 1.

74. Program instructions for programming computer apparatus which, when executed on programmable computer apparatus, cause the programmable computer apparatus to function as the system of claim 53.

75. A signal comprising program instructions as claimed in claim 73.

76. A computer readable medium storing program instructions as claimed in claim 75.
